(19) United States
(12) Patent Application Publication
(10) Pub. No.: US 2005/0162419 A1
(43) Pub. Date: Jul. 28, 2005

(54) System and method for 3-dimension simulation of glasses

(76) Inventors: So Woon Kim, Seongnam (KR); Seung Won Yi, Seoul (KR); Hang Shin Cho, Seongnam (KR); Sung Il Choi, Seoul (KR)

Correspondence Address: CANTOR COLBURN, LLP, 55 GRIFFIN ROAD SOUTH, BLOOMFIELD, CT, 06002, US

(21) Appl. No.: 10/509,257

(22) PCT Filed: Mar. 26, 2003
(86) PCT No.: PCT/KR03/00603

(30) Foreign Application Priority Data
Mar. 26, 2002 (KR) 10-2002-0016305
May 15, 2002 (KR) 10-2002-0026705
Jun. 10, 2002 (KR) 10-2002-0032374

(51) Int. Cl. G06K 9/48; G06K 9/46; G06T 15/00; G06T 17/00; G09G 5/00; G06F 19/00

(52) U.S. Cl. 345/419; 382/195; 382/190; 382/199; 345/420; 345/621; 345/629; 700/182

(57) ABSTRACT

A 3D virtual simulation system and method that provide decision-making information for selection and purchase of eyeglasses is presented. The system is comprised of four major units: 3D graphic simulation unit, contents delivery unit intelligent, Customer Relation Management (CRM) unit and back-office unit. 3D graphic simulation unit generates 3D face models of a user face and eyeglasses, and fit those objects automatically on networked platforms at real-time. The 3D face model is created from photo images of the face with options to select hair models. The 3D eyeglasses model is generated by a systematic reverse engineering process with specially designed measuring device. Graphic simulation unit transacts with intelligent CRM unit, so that user behavior is tracked down for push-marketing activity. Contents are delivered in a form of service-on-demand and ASP (Application Service Provider). This system enables precise virtual simulation of wearing eyeglasses with real dimensions of face and eyeglasses models and provides data and tools for custom-made production of eyeglasses assisted by expert knowledge base.

### BACKGROUND OF INVENTION

1. Field of Invention

The present invention relates to a system and method for 3D simulation of eyeglasses that provide decision-making information for selection and purchase of eyeglasses with virtual simulation technology.

2. Description of the Prior Technology

Eyeglasses are optical products and the fashion products as well. Major factors in decision-making process in this type of products are the product features such as design, material and price. In offline purchase, these factors are normally determined by customer's own will, fashion trend and suggestion from sellers or opticians.

Above business transaction in offline environment generates some barriers to adopt e-Commerce technologies on variety of online platforms. This problem can be summarized as following.

Firstly, virtual-try-on of eyeglasses has been online environment is very limited so far. Vast majority of current methods use 2D image position method that layers photo images of eyeglasses and face. This approach has limitations by nature because 2D images do not fully describe the characteristics of eyeglasses products and faces.

Secondly, a customer should make his or her own decision to purchase an item from online environment wherein very limited advice can be provided. Even in case there is advising feature, it is not very likely that the advise take characteristics of each customer into account as it is typically done in offline business. Therefore, in order to fully utilize online business of eyeglasses, an intelligent service method to provide dedicated support to customers as in offline space is needed.

Thirdly, e-Commerce on online platforms should provide its own advantage that overcomes the limitations of offline business, such as displaying only items in stock, inconsistency in advise from opticians and unreasonable pricing.

In the meantime, offline business also can be benefited by utilizing recent advance in software technology for e-Commerce. As stated above, offline business relies on items in stock that are displayed in offline shops. It has not been easy to sell items that are not actually displayed in the shop and to deliver sufficient product information that are out of stock with printed materials. Therefore, this convention has limited range of selection from the customer's point of view and limited sale opportunity from the seller's point of view.

In order to overcome the limitations in offline business stated above, number of image-based software technologies has been applied up to present. Those can be categorized by 2D-based and 3D-based approaches.

2D-based approach is the most commonly used approach that many e-Commerce companies adopted in early stage of Internet business. This approach utilizes an image composition method that layers photo images of eyeglasses and face models. This is a low-end solution for virtual-try-on, but has many limitations due to its nature of 2D image. Especially, as eyeglasses design tends to highly curved shape, this approach does not provide exact information of the product by the images only taken from front-side view.

On the other hand, by virtue of recent advance in computer graphics and processing power of CPU in personal computers, some of 3D based approaches have been researched in recent years. There have been mainly two different methods in this approach. The first method is so-called ‘panorama image’ where series of 2D images are connected together, so that a user can visualize 3D shape of eyeglasses as he or she moves the mouse on the screen. This is a pseudo way of 3D visualization because there is actually no 3D entity is generated while proving a 3D-like effect. As this method does not maintain any 3D object, it is not possible to publish interactive contents like placing eyeglasses model onto a human face model. Therefore, this method has only been applied to enhance visual description of the eyeglasses product on the Internet platforms.

### SUMMARY OF INVENTION

The technical goal of the present invention is to overcome disadvantages of preceding 2D and 3D approaches by providing the most realistic virtual-try-on of eyeglasses using 3D geometrical entities for eyeglasses and face models.

Additional goal of the present invention is to provide an effective decision-making support by an intelligent Customer Relation Management (CRM) facility. This facility operates computer-based learning, analysis for customer behavior, analysis for product preference, computer-based advice for fashion trend and design, and a knowledge base for acquired information. This facility also provides a facility for custom-made eyeglasses by that a customer can build his or her own design.

Often time, depending on the party who requests technical transactions, a technology can be categorized as ‘pull-type’ or ‘push-type’. The technical components illustrated above can be categorized as pull-type technologies as the contents can be retrieved upon user's request. Meanwhile, the present invention also consists of push-type marketing tools that publish marketing contents by utilizing virtual-try-on of eyeglass products on potential customers and deliver the contents via wired or wireless platforms without having user's request in advance.

### BRIEF DESCRIPTION OF THE FIGURES

FIG. 1 shows the service diagram for the 3D eyeglasses simulation system over the network.

FIG. 2 shows the detail diagram of the 3D eyeglasses simulation system.

FIG. 3a illustrates the texture generation flow for custom-made eyeglasses.

FIG. 3b shows an example of simulation of the custom-made eyeglasses.

FIG. 3c shows an example of the 3D eyeglasses simulation system implemented on a mobile device.

FIG. 4a and FIG. 4b shows database structure of the 3D eyeglasses simulation system.

FIG. 5 shows a diagram for the 3D face model generation operative

FIG. 6a, FIG. 6b, FIG. 6c and FIG. 6d show predefined windows of template for facial feature implemented in this invention.

FIG. 7, FIG. 8 and FIG. 9 illustrate operatives for facial feature and outline profile extraction.

FIG. 10 illustrates the flow of the template matching method.

FIG. 11 to FIG. 14 show 3D face generation operative on client network.

FIG. 15 shows a real-time preview operative in 3D face model generation operative.

FIG. 16a shows an example of the 3D simulation system implemented on web browser.

FIG. 16b shows an example of the virtual fashion simulation using 3D virtual human model.

FIG. 17 shows the structure of intelligent CRM unit.

FIG. 18 illustrates the business model utilizing the present invention

FIG. 18a shows an example of 1:1 marketing by e-mail.

FIG. 18b shows an example of 1:1 marketing contents on mobile devices.

FIG. 19 shows the diagram for 3D eyeglasses model management operative.

FIG. 20 illustrates the flow for automatic eyeglasses fitting.

FIG. 21 shows the measuring device for reverse modeling of eyeglasses.

FIG. 22a shows an example of a side view image imported from the measuring device.

FIG. 22b shows an example of a front view image imported from the measuring device.

FIG. 22c to FIG. 22e show examples of parametric reverse modeling of lenses.

FIG. 22f illustrates the flow of reverse modeling procedure of eyeglasses.

FIG. 23a to FIG. 27 show examples of detailed modeling of eyeglasses.

FIG. 28 and FIG. 29 illustrate the predefined fitting points for automatic fitting of eyeglasses.

FIG. 30 to FIG. 35b illustrate the process to fit 3D eyeglasses on to 3D face model.

FIG. 36 illustrates the result of automatic fitting and virtual try-on.

FIG. 37 illustrates the fitting points in the head model for auto-fitting process.

FIG. 38 illustrates the fitting points in the eyeglasses model for auto-fitting process.

FIG. 39 illustrates the fitting points in the hair model for auto-fitting process.

FIG. 40 illustrates the fitting points in the head model from different angle.

FIG. 41 illustrates the automatic fitting process of 3D hair model.

FIG. 42 illustrates the flow of the automatic fitting process for 3D eyeglasses simulation.

FIG. 43 illustrates the flow of the 3D eyeglasses simulation method.

FIG. 44 illustrates the flow of the avatar service flow over the internet platforms.

FIG. 45 illustrates the overall flow of the eyeglasses simulation.

### DESCRIPTION OF THE PREFERRED EMBODIMENT

The present invention provides a new system and method for 3D simulation of eyeglasses through real-time 3D graphics and intelligent knowledge management technologies.

In the present invention to overcome the limitation in preceding technology, this virtual simulation system, connected to a computer network, generates a 3D face model of a user, fits the face model and 3D eyeglasses models selected by the user, and simulates them graphically with a database that stores the information of users, products, 3D models and knowledge base. Above system is consist of following units: a user data processing unit to identify the user who needs to have an access to simulation system, and to generate a 3D face model of the user; a graphic simulation unit where a user can visualize 3D eyeglasses model that is generated as the user selects a product in the database, and to place and to fit automatically in 3D space on user's face model created in user data processing module; an intelligent CRM (Customer Relation Management) unit that can advise the user by a knowledge base that provides consulting information acquired by knowledge of fashion expert, purchase history and customer behavior on various products.

User data processing unit comprises a user information management operative to identify authorized user who have a legal access to the system and to maintain user information at each transaction with database and a 3D face model generation operative to create a 3D face model of a user by the information retrieved by the user.

3D face model generation operative comprises a data acquisition operative to generate a 3D face model of a user by a image capturing device connected to a computer, or by retrieving front or front-and-side view of photo images of the face, or by manipulating 3D face model stored in the database of 3D eyeglasses simulation system.

This operative also comprises a facial feature extraction operative to generate feature points of a base 3D model as a user input a outline profile and feature points of the face on a device that displays acquired photo images of the face, and to generate a base 3D model. Feature points of a face comprises predefined reference points on outline profile, eyes, nose, mouth and ears of a face.

The 3D face model generation operative further comprises a 3D face model deformation operative to retrieve precise coordinates points by user interaction, and to deform a base 3D model by relative displacement of reference points from default location by calculated movement of feature points and other points in the vicinity.

The Facial feature extraction operative comprises a face profile extraction operative to extract outline profile of 3D face model from the reference points input by the user and a feature point extraction operative to extract feature points that characterize the face of the user from the reference points on of eyes, nose, mouth and ears input by the user.

The 3D face model generation operative further comprises a facial expression operative to deform a 3D face model at-real time to generate human expressions under user's control.

The 3D face model generation operative further comprises a face composition operative to create a new virtual model by combining a 3D face model of a user generated by the face model deformation operative with that of the others.

The 3D face model generation operative further comprises a face texture generation operative to retrieve texture information from photo images provided by a user, to combine textures acquired from front and side view of the photo images and to generate textures for the unseen part of head and face on the photo images.

The 3D face model generation operative further comprises a real-time preview operative to display 3D face and eyeglasses models with texture over the network, and to display deformation process of the models.

The 3D face model generation operative further comprises a file managing operative to create and save 3D face model in proprietary format and to convert 3D face model data into industry standard formats.

The graphic simulation unit comprises a 3D eyeglasses model management operative to retrieve and store 3D model information on the database by user interaction, a texture generation operative to create colors and texture pattern of 3D eyeglasses models, and to store the data in the database, and to display textures of 3D models on a monitor generated in user data processing unit and eyeglasses modeling operative and a virtual-try-on operative to place 3D eyeglasses and face model in 3D space and to display.

The 3D eyeglasses model management operative comprise: an eyeglasses modeling operative to create a 3D model and texture of eyeglasses and to generate fitting parameters for virtual-try-on that include reference points for the gap distance between the eyes and lenses, hinges in eyeglasses and contact points on ears; a face model control operative to match fitting parameters generated in eyeglasses modeling operative.

The 3D virtual-try-on operative comprises: an automatic eyeglasses model fitting operative to deform a 3D eyeglasses model to match a 3D face model automatically at real-time on precise location by using fitting parameters upon user's selection of eyeglasses and face model; an animation operative to display prescribed animation scenarios to illustrate major features of eyeglasses models; a real-time rendering operative to rotate, move, pan, and zoom 3D models by user interaction or by prescribed series of interaction.

The 3D virtual-try-on operative further comprises a custom-made eyeglasses simulation operative to build user's own design by combining components of eyeglasses that include lenses, frames, hinges, temples and bridges from built-in library of eyeglasses models and texture and to place imported images of user's name or character to a specific location to build user's own design: to store simulated design in user data processing unit.

The system for 3D simulation of eyeglasses further comprises a commerce transaction unit to operate a merchant process so that a user can purchase the products after trying graphic simulation unit.

The commerce transaction unit comprises a purchase management operative to manage orders and purchase history of a user, a delivery management operative to verify order status and to forward shipping information to delivery companies and a inventory management operative to manage the status of inventory along with payment and delivery process.

The intelligent CRM unit comprises: a product preference analysis operative to analyze the preference on individual product by demographic characteristics of a user and of a category, and to store the analysis result on knowledge base; a customer behavior analysis operative to analyze the characteristics of a user's action on commerce contents, and to store the analysis result on knowledge base; an artificial intelligent learning operative to integrate analysis about from product preference and customer behavior with fashion trend information provided by experts in fashion, and to forecast future trend of fashion from acquired knowledge base; a fashion advise generation operative to create advising data from the knowledge base and store it to the database of 3D eyeglasses simulation system, and to deliver dedicated consulting information upon user's demand that include design, style and fashion trend suited for a specific user. The knowledge base comprises a database for log analysis and for advise on fashion trend.

In the present invention to overcome the limitation in preceding technology, a method for 3D simulation of eyeglasses for a 3D eyeglasses simulation system connected to a computer network to generate a 3D face model of a user, and to fit the face model and 3D eyeglasses models selected by the user, and to simulate them graphically with a database that stores the information of users, products, 3D models and knowledge base comprises: a step to generate 3D face model of the user as the user transmit photo images of his or her face to the 3D eyeglasses simulation system, or as the user select one of 3D face model stored in said database; a step to generate 3D eyeglasses model that selects one of 3D models stored in said database and generates 3D model parameters of said eyeglasses model for simulation; a step to simulate virtual-try-on on display monitor that fits said 3D eyeglasses and face model by deforming eyeglasses model at-real time, and that displays combined 3D mages of eyeglasses and face model at different angles.

The he step to generate a 3D face model of the user comprises a step to display image information from the input provided by the user a step to extract an outline profile and feature points of said face as the user input base feature points on displayed image information and a step to create a 3D face model by deforming base 3D model with a movement of base feature points observed during user interaction.

The step to extract an outline profile and feature points of said face comprises a step to create a base snake as the user input base feature points that include facial features points along outline and featured parts of the face, a step to define vicinity of said snake to move on each points along the snake to vertical direction and a step to move said snake to the direction where color maps of the face in said image information exist.

The step to extract outline profile and feature points of said face extract similarity between image information of featured parts of the face input by the user and that of predefined generic model.

The step to create a 3D face model comprises a step to generate Sibson coordinates of the base feature points a step to calculate movement of the base feature points to that of said image information and step to calculate a new coordinates of the base feature points as a summation of coordinates of the default position and the calculated movement.

The step to create a 3D face model comprises a step to calculate movement coefficients as a function of movement of the base feature points and a step to calculate new positions of feature points near base points by multiplying movement coefficient.

The method for 3D simulation of eyeglasses further comprises a step to generate facial expressions by deforming said 3D face model generated from said step to create a 3D face model and by using additional information provided by the user.

The step to generate facial expressions comprises a step to compute the first light intensity on the entire points over the 3D face model, a step to compute the second light intensity of the image information provided by the user, a step to calculate the ERI (Expression Ratio Intensity) value with the ratio of said second light intensity over that of said second and a step to warp polygons of the face model by using the ERI value to generate human expressions.

The method for 3D simulation of eyeglasses further comprises a step to combine photo image information of the front and side view of the face, and to generate textures of the remaining parts of the head that are unseen by said photo image.

The generate textures of remaining parts of the head comprises a step to generate Cartesian coordinates of said 3D face model and to generate texture coordinates of the front and side image of the face, a step to extract a border of said two images and to project the border onto the front and side views to generate textures in the vicinity of the border on the front and side views and a step to blend textures from the front and side views by referencing acquired texture on the border.

The method for 3D simulation of eyeglasses, before the step to generate 3D face model of the user, comprises: the first step to check whether the user's 3D face model has been registered before or not; the second step to check whether the user will update registered models or not; the third step to check whether the registered model has been generated by photo image provided by the user or by built-in 3D face model library; the fourth step to load the selected model when it is generated form the information provided by the user.

The method for 3D simulation of eyeglasses further comprises: the fifth step to confirm whether the user will generate a new face model or not when a stored model does not exist; the sixth step to display built-in default models when the user does not want to generate a new model; the seventh to create an avatar from 3D face model generated by photo image of the user by installing dedicated software on personal computer when the software has not been installed before in case the user wants to generate a 3D face model; the eighth step to register the avatar information and to proceed to the third step to check whether the model has been registered or not.

The method for 3D simulation of eyeglasses proceeds to the seventh step and to complete remaining process when the user wants to update the 3D face model in the second step.

The method for 3D simulation of eyeglasses further comprises a step to display the last saved model that has been selected in said third step.

The method for 3D simulation of eyeglasses that checks whether the user has been registered or not as in said first step and identifies that the user is the first visitor comprises a step to check whether the user select one of built-in default models or not after providing login procedure, a step to display selected default models on the monitor and a step to check to proceed to said seventh step if the user does not select any of built-in default model.

The method for 3D simulation of eyeglasses further comprises a step to select a design of frame and lenses, brand, color, materials or pattern from built-in library for the user.

The step to generate 3D eyeglasses model that selects one of 3D models stored in the database further comprises a step to provide fashion advise information to the user by intelligent CRM unit can advise the user by a knowledge base that provides consulting information acquired by knowledge of fashion expert, purchase history and customer behavior on various products.

The step to simulate on display monitor comprises: a step to scale eyeglasses model with respect to X-direction, that is the lateral direction of the 3D face model, by referencing fitting points at eyeglasses and face model that consists of the distance between face and far end part of eyeglasses, hinges in eyeglasses and contact points on ears; a step to transform coordinates of Y-direction, that is up and downward direction to the 3D face model, and Z-direction, that is front and backward direction to the 3D face model, with the scale calculated in X-direction; a step deform temple part of the 3D eyeglasses model to match corresponding fitting points between 3D face and eyeglasses model.

The scale factor that scales the size of 3D eyeglasses model for automatic fitting represented by:
SF=X_{B}/X_{B}′,
g=SF·G

Where, SF is the scale factor, X_{B}′ is the X-coordinate of the fitting point B′ for the hinge part of 3D eyeglasses model and X_{B} is the X-coordinate of the corresponding fitting point B for the 3D face model G is the size of original 3D eyeglasses model and g is a scaled size of the model in X-direction.

The method for 3D simulation of eyeglasses comprises the movement in Y-direction to close the gap between the fitting point B for 3D face model and the scaled fitting point b′ by said scale factor for the hinge part of 3D eyeglasses model represented by:

$$Δ Y = {Y}_{B} - {Y}_{{b}^{′}} = {Y}_{B} - {Y}_{B}^{′} \cdot \frac{{X}_{B}}{{X}_{B}^{′}}$$

$${b}^{′} = ( {X}_{B}^{′} , {Y}_{B}^{′} \cdot \frac{{X}_{B}}{{X}_{B}^{′}} , {Z}_{B}^{′} \cdot \frac{{X}_{B}}{{X}_{B}^{′}} )$$

where, ΔY is the movement of 3D eyeglasses model in Y-direction, (X_{B}′, Y_{B}′, Z_{B}′) are the coordinates of the fitting point B′ for the hinge part of the 3D eyeglasses model, (X_{B}, Y_{B}, Z_{B}) are the coordinates of the corresponding fitting point B for the 3D face model and Y_{b′} is the Y-coordinate of the scaled fitting point b′.

The method for 3D simulation of eyeglasses comprises the movement in Z-direction to close the gap between the fitting point A for 3D face model and the scaled fitting point a′ by said scale factor for the hinge part of 3D eyeglasses model represented by:

$$Δ Z = ( {Z}_{A} - α ) - {Z}_{{a}^{′}} = {Z}_{A} + α - {Z}_{A}^{′} \cdot \frac{{X}_{B}}{{X}_{B}^{′}}$$

$${a}^{′} = ( {X}_{A}^{′} , {Y}_{A}^{′} \cdot \frac{{X}_{B}}{{X}_{B}^{′}} , {Z}_{A}^{′} \cdot \frac{{X}_{B}}{{X}_{B}^{′}} )$$

where, ΔZ is the movement of 3D eyeglasses model in Z-direction, (X_{A}′, Y_{A}′, Z_{A}′) are the coordinates of the fitting point A′ for the top center of a lens in the 3D eyeglasses model, (X_{A}, Y_{A}, Z_{A}) are the coordinates of the corresponding fitting point A for top center of an eyebrow in the 3D face model, Z_{a′} is the Z-coordinate of the scaled fitting point a′ and α is the relative distance between the top centers of the lens and the eyebrow.

The method for 3D simulation of eyeglasses comprises the rotation angle θ_{y} in X-Z plane with respect to Y-axis represented by the angle calculated from cosine function represented by:
Cos θ_{y}=Cos(∠CB′C′)_{X-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

The method for 3D simulation of eyeglasses comprises the rotation angle θₓ in Y-Z plane with respect to X-axis represented by the angle calculated from cosine function represented by:
Cos θₓ=Cos(∠CB′C′)_{Y-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

In the present invention to overcome the limitation in preceding technology, a storage media to read a program to from a computer network to generate a 3D face model of a user, and to fit the face model and 3D eyeglasses models selected by the user, and to simulate them graphically with a database that stores the information of users, products, 3D models and knowledge base, to execute a program comprises: an operative to generate 3D face model of the user as the user transmit photo images of his or her face to the 3D eyeglasses simulation system, or as the user select one of 3D face model stored in said database; an operative to generate 3D eyeglasses model that selects one of 3D models stored in said database and generates 3D model parameters of said eyeglasses model for simulation; an operative to simulate virtual-try-on on display monitor that fits said 3D eyeglasses and face model by transforming the Y and Z-coordinates of 3D eyeglasses model with the scale factor calculated from X-direction, using the gap distance between the eyes and the lenses and the fitting points for the ear part of the face model and for the hinge and the temple part of the eyeglasses model, and that displays combined 3D images of eyeglasses and face model at different angles.

The method to generate a 3D face model comprises: (a) a step to input a 2D photo image of a face in front view and to display said image; (b) a step to input at least one base points, on the said image, that characterizes a human face; (c) a step to extract an outline profile and feature points for eyes, nose, mouth and ears that construct feature shapes of said face; (d) a step to convert said input image information to a 3D face model using said outline profile and feature points.

The base points include at least one points in the outline profile of the face, and the step (c) to extract the outline profile of the face comprises: (c1) a step to generate a base snake on said face information on said image referencing said base points; (c2) a step to extract the outline profile by moving snake of the said face to the direction where textures of the face exist.

The base points include at least one points that correspond to eyes, nose, mouth and ears, and the step (c) to extract the outline profile of the face comprises: a step to comprise a standard image information for a standard 3D face model; (c2) a step to extract feature points of said input image by analyzing the similarity in image information of the featured shape and that of the standard image.

The step (a) to input said 2D image provides a facility to zoom in, zoom out or rotate said image upon user's demand, and the step (b) comprises: (b1) a step to input the size and degree of rotation of the said image by the user; (b2) a step to generate a vertical center line for the face and to input base points for outline profile of the face, the step (c) comprises: (c1) a step to generate base snake of the face by the said base points of the said image of the face; (c2) a step to extract outline profile of the face by moving said snake to the direction where texture of the face exist; (c3) a step to comprise standard image information for 3D face model; (c4) a step to extract feature points of said input image by analyzing the similarity in image information of the featured shape and that of the standard image; (c5) a step to display the outline profile or the feature points along the outline profile to the user, and to provide a facility to modify said profile or feature points, and to finalize the outline profile and feature points of said face.

The method to generate a 3D face model further comprises: (e) a step to generate 3D face model by deforming said face image information using the movement of base feature points in the standard image information to extracted feature points by user interaction on said face image.

The step (e) comprises: (e1) a step to generate Sibson coordinates on the original position of the base points extracted from the step to deform said face model; (e2) a step to calculate movements of each base points to the corresponding position of said image information; (e3) a step to calculate a new position with a summation of coordinates of the original positions and said movements; (e4) a step to generate 3D face model that corresponds to adjusted image information, by new positions, of said face.

The step (e) comprises: (e1) a step to calculate the movement of base points; (e2) a step to calculate new positions of base points and their vicinity that have by using said movement; (e3) a step to generate 3D face model that corresponds to adjusted image information, by new positions, of said face.

The method to generate a 3D face model further comprises: (f) a step to generate facial expressions by deforming said 3D face model generated from said step to create a 3D face model and by using additional information provided by the user.

The method to generate a 3D face model, the step (f) comprises: (f1) a step to compute the first light intensity on the entire points over the 3D face model; (f2) a step to compute the second light intensity of the image information provided by the user; (f3) a step to calculate the ERI (Expression Ratio Intensity) value with the ratio of said second light intensity over that of said second; (f4) a step to warp polygons of the face model by using the ERI value to generate human expressions.

The method to generate a 3D face model further comprises: (g) a step to combine photo image information of the front and side view of the face, and to generate textures of the remaining parts of the head that are unseen by said photo image.

The step (g) comprises: (g1) a step to generate Cartesian coordinates of said 3D face model and to generate texture coordinates of the front and side image of the face; (g2) a step to extract a border of said two images and to project the border onto the front and side views to generate textures in the vicinity of the border on the front and side views; (g3) a step to blend textures from the front and side views by referencing acquired texture on the border.

The method to generate a 3D face model further comprises: (h) a step to provide a facility for the user to select a hair models from a built-in library of 3D hair models, and to fit said hair model onto said 3D face model.

The step (h) comprises: (h1) a step to comprise a library of 3D hair models in at least one category in hair style; (h2) a step for the user to select a hair model from the built-in library of 3D hair models; (h3) a step to extract a fitting point for the 3D hair model that matches the top position of the scalp on the vertical center line of said 3D face model; (h4) a step to calculate the scale that matches to said 3D face model, and to fit 3D hair and face model together by using said fitting point for the hair.

In the present invention to overcome the limitation in preceding technology, the method for 3D simulation of eyeglasses comprising: (a) a step to acquire photographic image information from front, side and top views of eyeglasses placed in a cubic box with a measure in transparent material; (b) a step to generate a base 3D model for eyeglasses by using measured value from said images or by combining components from a built-in library for 3D eyeglasses component models and textures; (c) a step to generate a 3D lens model parametrically with the geometric information about lens shape, curvature, slope and focus angle; (d) a step to generate a shape of the bridge and frame of eyeglasses by using measured value from said image and to combine said lenses, bridge and frame model together to generate a 3D complete model for eyeglasses.

The step (c) comprises: (c1) a step to acquire curvature information from said images or by specification of the product, and to create a sphere model that matches said curvature or predefined curvature preference; (c2) a step to project the outline profile the lens to the surface of the sphere model and to trim out inner part of the projected surface.

The method for 3D simulation of eyeglasses further comprises: (c3) a step to generate thickness on trimmed surface of the lens.

The method for 3D simulation of eyeglasses, the step (d) comprises: (d1) a step to display the base 3D model to the user, and to acquire input parameters for adjusting the 3D frame model, and to deform said frame model with acquired parameters; (d2) a step to mirror said 3D lens model with respect to center line defined by user input or measured by said photo images and generate a pair of lenses in symmetry, and to generate a 3D bridge model with the parameters defined by user input or measured by said photo images.

The step (d) further comprises: (d3) a step to generate a connection part of the 3D frame model between temple and lens frame with the parameters defined by user input or measured by said photo images, or by the built-in 3D component library.

The method for 3D simulation of eyeglasses further comprises: (e) a step to generate temple part of the 3D frame model with the parameters defined by user input or measured by said photo images, or by the built-in 3D component library, while matching topology of said connection part and to convert automatically in a format of polygons; (f) a step to deform temple part of the 3D frame model to match the curvature measured by said photo images or predefined curvature preference; (g) a step to mirror said 3D temple model with respect to center line defined by user input or measured by said photo images and generate a pair of lenses in symmetry.

The method for 3D simulation of eyeglasses further comprises: (h) a step to generate a nose part, a hinge part, screws, bolts and nuts from with the parameters defined by user input or built-in 3D component library.

In the present invention to overcome the limitation in preceding technology, the method for 3D simulation of eyeglasses comprises: (a) a step to comprise at least one 3D eyeglasses and 3D face model information; (b) a step to select a 3D face model and 3D eyeglasses model by a user from said model information; (c) a step to fit automatically said face and eyeglasses model at-real time; (d) a step to compose a 3D image of said face and eyeglasses model, and to display generated said 3D image upon the user's demand.

The step (c) comprises: (c1) a step to adjust to the scale of the 3D eyeglasses model in X-direction, that is the lateral direction of the 3D face model, with the fitting points for hinge part of the 3D eyeglasses model, for corresponding fitting points in 3D face model, for top center of the ear part of the 3D face model, for gap distance between eyes and lenses; (c2) a step to transform the coordinates and the location of 3D eyeglasses model in Y-direction, that is up and downward direction to the 3D face model, and Z-direction, that is front and backward direction to the 3D face model, with the scale calculated in X-direction; (c3) a step to deform temple part of the 3D eyeglasses model to match corresponding fitting points between 3D face and eyeglasses model.

The step (c1) comprises the scale factor that scales the size of 3D eyeglasses model for automatic fitting represented by:
SF=X_{B}/X_{B}′,
g=SF·G

Where, SF is the scale factor, X_{B}′ is the X-coordinate of the fitting point B′ for the hinge part of 3D eyeglasses model and X_{B} is the X-coordinate of the corresponding fitting point B for the 3D face model, G is the size of original 3D eyeglasses model and g is a scaled size of the model in X-direction.

The method for 3D simulation of eyeglasses comprises the movement in Y-direction to close the gap between the fitting point B for 3D face model and the scaled fitting point b′ by said scale factor for the hinge part of 3D eyeglasses model represented by:

$$Δ Y = {Y}_{B} - {Y}_{{b}^{′}} = {Y}_{B} - {Y}_{B}^{′} \cdot \frac{{X}_{B}}{{X}_{B}^{′}}$$

$${b}^{′} = ( {X}_{B}^{′} , {Y}_{B}^{′} \cdot \frac{{X}_{B}}{{X}_{B}^{′}} , {Z}_{B}^{′} \cdot \frac{{X}_{B}}{{X}_{B}^{′}} )$$

Where, ΔY is the movement of 3D eyeglasses model in Y-direction, (X_{B}′, Y_{B}′, Z_{B}′) are the coordinates of the fitting point B′ for the hinge part of the 3D eyeglasses model, (X_{B}, Y_{B}, Z_{B}) are the coordinates of the corresponding fitting point B for the 3D face model and Y_{b′} is the Y-coordinate of the scaled fitting point b′.

The method for 3D simulation of eyeglasses comprises the movement in Z-direction to close the gap between the fitting point A for 3D face model and the scaled fitting point a′ by said scale factor for the hinge part of 3D eyeglasses model represented by:

$$Δ Z = ( {Z}_{A} - α ) - {Z}_{{a}^{′}} = {Z}_{A} + α - {Z}_{A}^{′} \cdot \frac{{X}_{B}}{{X}_{B}^{′}}$$

$${a}^{′} = ( {X}_{A}^{′} , {Y}_{A}^{′} \cdot \frac{{X}_{B}}{{X}_{B}^{′}} , {Z}_{A}^{′} \cdot \frac{{X}_{B}}{{X}_{B}^{′}} )$$

where, ΔZ is the movement of 3D eyeglasses model in Z-direction, (X_{A}′, Y_{A}′, Z_{A}′) are the coordinates of the fitting point A′ for the top center of a lens in the 3D eyeglasses model, (X_{A}, Y_{A}, Z_{A}) are the coordinates of the corresponding fitting point A for top center of an eyebrow in the 3D face model, Z_{a′} is the Z-coordinate of the scaled fitting point α′ and α is the relative distance between the top centers of the lens and the eyebrow.

The method for 3D simulation of eyeglasses comprises the rotation angle θ_{y} in X-Z plane with respect to Y-axis represented by the angle calculated from cosine function represented by:
Cos θ_{y}=Cos(∠CB′C′)_{X-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

The method for 3D simulation of eyeglasses comprises the rotation angle θₓ in Y-Z plane with respect to X-axis represented by the angle calculated from cosine function represented by:
Cos θₓ=Cos(∠CB′C′)_{Y-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

The step (c) comprises: (c1) a step to input center points of the fitting region, NF, CF, DF, NG, HG and CG, in that 3D eyeglasses model and 3D face model contact each other, where NF is the center point of said 3D face model, CF is the center top of the ear part of said 3D face model that contacts the temple part of the 3D eyeglasses model during virtual-try-on, DF is the point at the top of the scalp, NG is the center of the nose part of said 3D face model that contacts the nose pad part of the 3D eyeglasses model during virtual-try-on, HG is the rotational center of hinge part of the 3D eyeglasses model and CG is the center of inner side of the temple part of the 3D eyeglasses model that contact said ear part of the 3D face model; (c2) a step to obtain new coordinates set for said 3D eyeglasses model using said value of NF, CF, DF, NG, HG and CG that are need to fit eyeglasses on face model; (c3) a step to fit said 3D eyeglasses model on said 3D face model automatically at-real time.

The step (c2) comprises; (c2i) a step to move said 3D eyeglasses model to proper position by using the difference of said NF and said NG; (c2ii) a step for the user to input his or her own PD, pupillary distance, and to calculate PD value of said 3D face and corresponding value of 3D eyeglasses model; (c2iii) a step to calculate the rotation angles for the template part of said eyeglasses model in horizontal plane to be fitted on said 3D face model by using said CF and HG value; (c2iv) a step to deform 3D eyeglasses model and to fit on said 3D face model by using said values and angles.

The step (c2ii) comprises a step to define a value between 63 and 72 millimeters without having input from the user.

In the present invention to overcome the limitation in preceding technology, an eyeglasses marketing method comprises: (a) a step to generate 3D face model of a user a with a photo image of the face, and to generate image information to combine said 3D face model and stored 3D eyeglasses model, and to deliver said image information to a customer; (b) a step to retrieve at least one selection of the 3D eyeglasses model by the user, and to manage purchase inquiry information of the eyeglasses, that corresponds to 3D eyeglasses model, inputted by the user; (c) a step to analyze the environment where said purchase inquiry occurs including analysis or occasion of customer behavior on the corresponding inquiry and eyeglass product; (d) a step to analyze the customer's preference on eyeglasses product inquired and to manage the preference result; (e) a step to forecast trend future trend of fashion driven from said analysis step for product preference and analysis result for customer behavior and acquired information on eyeglasses fashion; (f) a step to acquire future trend of fashion by an artificial intelligent learning tool dedicated to fashion trend forecast, and to generate a knowledge base that advise suited design or proper fashion trend upon customer's request; (g) a step to generate a promotional contents for eyeglasses for a specific customer based on the integrated information about customer preference obtained from said customer behavior analysis tool, advising information generated by said knowledge base and artificial intelligent learning tool; (h) a step to acquire and manage demographic information of the user including email address or phone numbers, and to deliver promotional contents to the customer as a 1:1 marketing tool.

The step (g) comprises a step to categorize customers by a predefined rule and to generate promotional contents according to said category.

The step (d) and (e) comprises analysis for the customer that includes at least one parameter for hair texture of 3D face model of the customer, lighting of the face, skin tone, width of the face, length of the face, size of the mouth, interpupillary distance and race of the customer.

The step (d) comprises the analysis for the eyeglasses product that includes at least one parameter for size of the frame and lenses, shape of the frame and lenses, material of the frame and lenses, color of the frame, color of the lenses, model year, brand and price.

The step (d) comprises analysis for the product preference that includes at least one parameter for seasonal trend in fashion, seasonal trend of eyeglasses shape, width of the face, race, skin tone, interpupillary distance, and hairstyle in the 3D face model.

In the present invention to overcome the limitation in preceding technology, a device to generate a 3D face model comprises: an operative to input a 2D photo image of a face in front view and to display said image and to input at least one base points, on the said image, that characterizes a human face; an operative to extract an outline profile and feature points for eyes, nose, mouth and ears that construct feature shapes of said face; an operative to convert said input image information to a 3D face model using said outline profile and feature points.

The base points include at least one points in the outline profile of the face, and said operative to extract the outline profile of the face comprises: an operative to generate a base snake on said face information on said image referencing said base points; an operative to extract the outline profile by moving snake of the said face to the direction where textures of the face exist.

The base points include at least one points that correspond to eyes, nose, mouth and ears, and the operative to extract the outline profile of the face comprises: a database to comprise a standard image information for a standard 3D face model; an operative to extract feature points of said input image by analyzing the similarity in image information of the featured shape and that of the standard image.

The operative to input said 2D image provides a facility to zoom in, zoom out or rotate said image upon user's demand, retrieves the size and degree of rotation of the said image by the user, and generates a vertical center line for the face and to input base points for outline profile of the face, the operative to extract the outline profile of the face comprises: an operative to generate base snake of the face by the said base points of the said image of the face and to extract outline profile of the face by moving said snake to the direction where texture of the face exist; an operative to comprise a database of standard image information for 3D face model; an operative to extract feature points of said input image by analyzing the similarity in image information of the featured shape and that of the standard image; an operative to display the outline profile or the feature points along the outline profile to the user, and to provide a facility to modify said profile or feature points, and to finalize the outline profile and feature points of said face.

The device to generate a 3D face model further comprises an operative to generate 3D face model by deforming said face image information using the movement of base feature points in the standard image information to extracted feature points by user interaction on said face image.

The operative to deform 3D face model comprises an operative to generate Sibson coordinates on the original position of the base points extracted from the operative to deform said face model, an operative to calculate movements of each base points to the corresponding position of said image information, an operative to calculate a new position with a summation of coordinates of the original positions and said movements and an operative to generate 3D face model that corresponds to adjusted image information, by new positions, of said face.

The operative to deform 3D face model an operative to calculate the movement of base points, an operative to calculate new positions of base points and their vicinity that have by using said movement and an operative to generate 3D face model that corresponds to adjusted image information, by new positions, of said face.

The device to generate a 3D face model further comprises an operative to generate facial expressions by deforming said 3D face model generated from said operative to create a 3D face model and by using additional information provided by the user.

The operative to generate facial expressions comprises an operative to compute the first light intensity on the entire points over the 3D face model, an operative to compute the second light intensity of the image information provided by the user, an operative to calculate the ERI (Expression Ratio Intensity) value with the ratio of said second light intensity over that of said second and an operative to warp polygons of the face model by using the ERI value to generate human expressions.

The device to generate a 3D face model further comprises an operative to combine photo image information of the front and side view of the face, and to generate textures of the remaining parts of the head that are unseen by said photo image.

The operative comprises: an operative to generate Cartesian coordinates of said 3D face model and to generate texture coordinates of the front and side image of the face; an operative to extract a border of said two images and to project the border onto the front and side views to generate textures in the vicinity of the border on the front and side views; an operative to blend textures from the front and side views by referencing acquired texture on the border.

The device to generate a 3D face model further comprises an operative to provide a facility for the user to select a hair models from a built-in library of 3D hair models, and to fit said hair model onto said 3D face model.

The operative comprises: an operative to comprise a library of 3D hair models in at least one category in hair style; an operative for the user to select a hair model from the built-in library of 3D hair models; an operative to extract a fitting point for the 3D hair model that matches the top position of the scalp on the vertical center line of said 3D face model; an operative to calculate the scale that matches to said 3D face model, and to fit 3D hair and face model together by using said fitting point for the hair.

In the present invention to overcome the limitation in preceding technology, a device to generate a 3D eyeglasses model comprising: an operative to acquire photographic image information from front, side and top views of eyeglasses placed in a cubic box with a measure in transparent material; an operative to generate a base 3D model for eyeglasses by using measured value from said images; an operative to generate a 3D lens model parametrically with the geometric information about lens shape, curvature, slope and focus angle; an operative to generate a shape of the bridge and frame of eyeglasses by using measured value from said image and to combine said lenses, bridge and frame model together to generate a 3D complete model for eyeglasses.

The operative to generate a 3D lens model comprises an operative to acquire curvature information from said images and to create a sphere model that matches said curvature or predefined curvature preference, and an operative to project the outline profile the lens to the surface of the sphere model and to trim out inner part of the projected surface.

The device to generate a 3D eyeglasses model further comprises an operative to generate thickness on trimmed surface of the lens.

The operative to generate a 3D model comprises: an operative to display the base 3D model to the user, and to acquire input parameters for adjusting the 3D frame model, and to deform said frame model with acquired parameters; an operative to mirror said 3D lens model with respect to center line defined by user input or measured by said photo images and generate a pair of lenses in symmetry, and to generate a 3D bridge model with the parameters defined by user input or measured by said photo images.

The operative to generate a 3D model comprises further comprises an operative to generate a connection part of the 3D frame model between temple and lens frame with the parameters defined by user input or measured by said photo images, or by built-in 3D component library.

The device to generate a 3D eyeglasses model further comprises: an operative to generate temple part of the 3D frame model while matching topology of said connection part and to convert automatically in a format of polygons; an operative a step to deform temple part of the 3D frame model to match the curvature measured by said photo images or predefined curvature preference; an operative a step to mirror said 3D temple model with respect to center line defined by user input or measured by said photo images and generate a pair of lenses in symmetry.

The device to generate a 3D eyeglasses model further comprises an operative to generate a nose part, a hinge part, a screw, a bolt and a nut from with the parameters defined by user input or built-in 3D component library.

In the present invention to overcome the limitation in preceding technology, a device for 3D simulation of eyeglasses is consist of: a database that comprises at least one 3D eyeglasses and 3D face model information; an operative to select a 3D face model and 3D eyeglasses model by a user from said model information; an operative to fit automatically said face and eyeglasses model at-real time; an operative to compose a 3D image of said face and eyeglasses model, and to display generated said 3D image upon the user's demand.

The operative to fit eyeglasses model comprises: an operative to adjust to the scale of the 3D eyeglasses model in X-direction, that is the lateral direction of the 3D face model, with the fitting points for hinge part of the 3D eyeglasses model, for corresponding fitting points in 3D face model, for top center of the ear part of the 3D face model, for gap distance between eyes and lenses; an operative to transform the coordinates and the location of 3D eyeglasses model in Y-direction, that is up and downward direction to the 3D face model, and Z-direction, that is front and backward direction to the 3D face model, with the scale calculated in X-direction; an operative to deform temple part of the 3D eyeglasses model to match corresponding fitting points between 3D face and eyeglasses model.

The operative to adjust the scale comprises the scale factor that scales the size of 3D eyeglasses model for automatic fitting represented by:
SF=X_{B}/X_{B}′,
g=SF·G

Where, SF is the scale factor, X_{B}′ is the X-coordinate of the fitting point B′ for the hinge part of 3D eyeglasses model and X_{B} is the X-coordinate of the corresponding fitting point B for the 3D face model, G is the size of original 3D eyeglasses model and g is a scaled size of the model in X-direction.

The device for 3D simulation of eyeglasses comprises the movement in Y-direction to close the gap between the fitting point B for 3D face model and the scaled fitting point b′ by said scale factor for the hinge part of 3D eyeglasses model represented by:

$$Δ Y = {Y}_{B} - {Y}_{{b}^{′}} = {Y}_{B} - {Y}_{B}^{′} \cdot \frac{{X}_{B}}{{X}_{B}^{′}}$$

$${b}^{′} = ( {X}_{B}^{′} , {Y}_{B}^{′} \cdot \frac{{X}_{B}}{{X}_{B}^{′}} , {Z}_{B}^{′} \cdot \frac{{X}_{B}}{{X}_{B}^{′}} )$$

where, ΔY is the movement of 3D eyeglasses model in Y-direction, (X_{B}′, Y_{B}′, Z_{B}′) are the coordinates of the fitting point B′ for the hinge part of the 3D eyeglasses model, (X_{B}, Y_{B}, Z_{B}) are the coordinates of the corresponding fitting point B for the 3D face model and Y_{b′} is the Y-coordinate of the scaled fitting point b′.

The device for 3D simulation of eyeglasses comprises the movement in Z-direction to close the gap between the fitting point A for 3D face model and the scaled fitting point a′ by said scale factor for the hinge part of 3D eyeglasses model represented by:

$$Δ Z = ( {Z}_{A} - α ) - {Z}_{{a}^{′}} = {Z}_{A} + α - {Z}_{A}^{′} \cdot \frac{{X}_{B}}{{X}_{B}^{′}}$$

$${a}^{′} = ( {X}_{A}^{′} , {Y}_{A}^{′} \cdot \frac{{X}_{B}}{{X}_{B}^{′}} , {Z}_{A}^{′} \cdot \frac{{X}_{B}}{{X}_{B}^{′}} )$$

where, ΔZ is the movement of 3D eyeglasses model in Z-direction, (X_{A}′, Y_{A}′, Z_{A}′) are the coordinates of the fitting point A′ for the top center of a lens in the 3D eyeglasses model, (X_{A}, Y_{A}, Z_{A}) are the coordinates of the corresponding fitting point A for top center of an eyebrow in the 3D face model, Z_{a′} is the Z-coordinate of the scaled fitting point a′ and α is the relative distance between the top centers of the lens and the eyebrow.

The device for 3D simulation of eyeglasses comprises the rotation angle θ_{y} in X-Z plane with respect to Y-axis represented by the angle calculated from cosine function represented by:
Cos θ_{y}=Cos(∠CB′C′)_{X-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

The device for 3D simulation of eyeglasses comprises the rotation angle θₓ in Y-Z plane with respect to X-axis represented by the angle calculated from cosine function represented by:

where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

The operative to fit 3D eyeglasses comprises: an operative to input center points of the fitting region, NF, CF, DF, NG, HG and CG, in that 3D eyeglasses model and 3D face model contact each other, where NF is the center point of said 3D face model, CF is the center top of the ear part of said 3D face model that contacts the temple part of the 3D eyeglasses model during virtual-try-on, DF is the point at the top of the scalp, NG is the center of the nose part of said 3D face model that contacts the nose pad part of the 3D eyeglasses model during virtual-try-on, HG is the rotational center of hinge part of the 3D eyeglasses model and CG is the center of inner side of the temple part of the 3D eyeglasses model that contact said ear part of the 3D face model; an operative to obtain new coordinates set for said 3D eyeglasses model using said value of NF, CF, DF, NG, HG and CG that are need to fit eyeglasses on face model; an operative to fit said 3D eyeglasses model on said 3D face model automatically at-real time.

The operative to obtain new coordinates comprises; an operative to move said 3D eyeglasses model to proper position by using the difference of said NF and said NG; an operative a step for the user to input his or her own PD, pupillary distance, and to calculate PD value of said 3D face and corresponding value of 3D eyeglasses model; an operative a step to calculate the rotation angles for the template part of said eyeglasses model in horizontal plane to be fitted on said 3D face model by using said CF and HG value; an operative a step to deform 3D eyeglasses model and to fit on said 3D face model by using said values and angles.

The step (c2ii) comprises a step to define a value between 63 and 72 millimeters without having input from the user.

In the present invention to overcome the limitation in preceding technology, a device for marketing of eyeglasses comprises: an operative to generate 3D face model of a user a with a photo image of the face, and to generate image information to combine said 3D face model and stored 3D eyeglasses model, and to deliver said image information to a customer; an operative to retrieve at least one selection of the 3D eyeglasses model by the user, and to manage purchase inquiry information of the eyeglasses, that corresponds to 3D eyeglasses model, inputted by the user; an operative to analyze the environment where said purchase inquiry occurs including analysis or occasion of customer behavior on the corresponding inquiry and eyeglass product; an operative to analyze the customer's preference on eyeglasses product inquired and to manage the preference result; an operative to forecast trend future trend of fashion driven from said analysis step for product preference and analysis result for customer behavior and acquired information on eyeglasses fashion; an operative to acquire future trend of fashion by an artificial intelligent learning tool dedicated to fashion trend forecast, and to generate a knowledge base that advise suited design or proper fashion trend upon customer's request; an operative to generate a promotional contents for eyeglasses for a specific customer based on the integrated information about customer preference obtained from said customer behavior analysis tool, advising information generated by said knowledge base and artificial intelligent learning tool; an operative to acquire and manage demographic information of the user including email address or phone numbers, and to deliver promotional contents to the customer as a 1:1 marketing tool.

The operative to provide 1:1 marketing tool comprises an operative to categorize customers by a predefined rule and to generate promotional contents according to said category.

The device for marketing of eyeglasses comprises analysis for the customer that includes at least one parameter for hair texture of 3D face model of the customer, lighting of the face, skin tone, width of the face, length of the face, size of the mouth, interpupillary distance and race of the customer.

The device for marketing of eyeglasses comprises the analysis for the eyeglasses product that includes at least one parameter for size of the frame and lenses, shape of the frame and lenses, material of the frame and lenses, color of the frame, color of the lenses, model year, brand and price.

The device for marketing of eyeglasses comprises analysis for the product preference that includes at least one parameter for seasonal trend in fashion, seasonal trend of eyeglasses shape, width of the face, race, skin tone, interpupillary distance, and hairstyle in the 3D face model.

### DESCRIPTION OF THE PREFERRED EMBODIMENT

The embodiments of the present invention will be illustrated with reference to accompanying drawings.

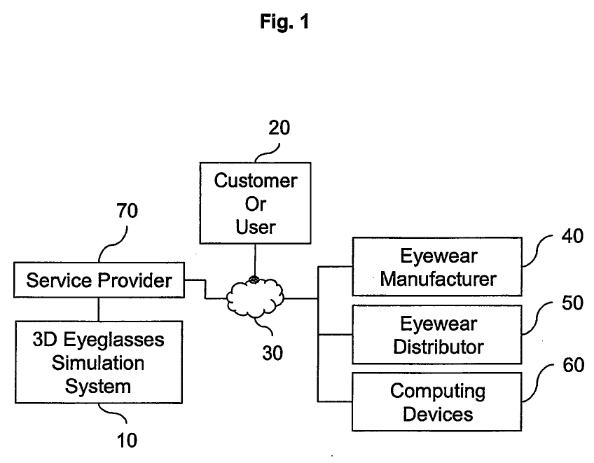

FIG. 1 is an example of the service for 3D eyeglasses simulation system over the network.

As illustrated in FIG. 1, 3D eyeglasses simulation system (10) is connected to a communication device (20) of a customer (user) via telecommunication networks such as Internet that are available by internet service providers (70). A user can generate his or her own 3D face model and try that on 3D eyeglasses model that have been generated by the system (70) beforehand. An intelligent Customer Relation Management (CRM) knowledge base incorporated in the system assists decision-making process of customers by analyzing fashion trend and customer behavior and delivers advice information to different types of telecommunication form factors (60).

A user can use a photo image of his or her own face by using image capturing device attached to user's communication device (20) such as a web-camera or a digital camera, or can retrieve a image that is stored in the system (10), or just can try 3D simulation with provided built-in sample avatars.

3D eyeglasses simulation system (10) provides merchant process when the user requests purchase inquiry after virtual-try-on of eyeglasses: The system (10) can be operated by a eyeglasses manufacturer (40), a seller (50) directly by its personnel or indirectly by partnership with independent service providers. For the latter case, log data and merchant information is delivered to the manufacturer (40). Upon arrival of the purchase information, the manufacturer delivers the products to the sellers using electronically managed logistics pipeline.

A service provider (70) provides liable services to customers, manufacturers (40), or sellers (50) by allowing authorized permissions to 3D eyeglasses system (10). In addition, an electronic catalogue published by the manufacturer (40) or the seller (50) can be integrated with the system (10) and can also be the other e-Commerce platforms.

The manufacturer (40) or the seller (50) can utilize 3D eyeglasses simulation system (10) as a way to promote eyeglasses product by delivering virtual-try-on contents to customers (20), buyers (40) and other sellers (50) through telecommunication form factors (60).

3D eyeglasses simulation system (10) not only provides online service through telecommunication networks, but also provides a facility to publish software and database to embed in variety of platforms such as Kiosk, tablet-PC, pocket-PC, PDA, smart display and mobile phones (60). With this compatibility, offline business also can benefit from simulative technology.

When 3D eyeglasses system is published in a storage media and distributed in offline market, eyeglasses selection process is performed in offline space by a customer who visits the shop or the show room, generated information is delivered to online platforms automatically. Once the user's information has been stored in the database of the system (10), the user can perform remaining process in online environment (70). This service is extended to provide custom-made production service to a customer by that a user can build his or her own design with the 3D face model information of the user acquired in offline space.

1. A System for 3D Simulation of Eyeglasses

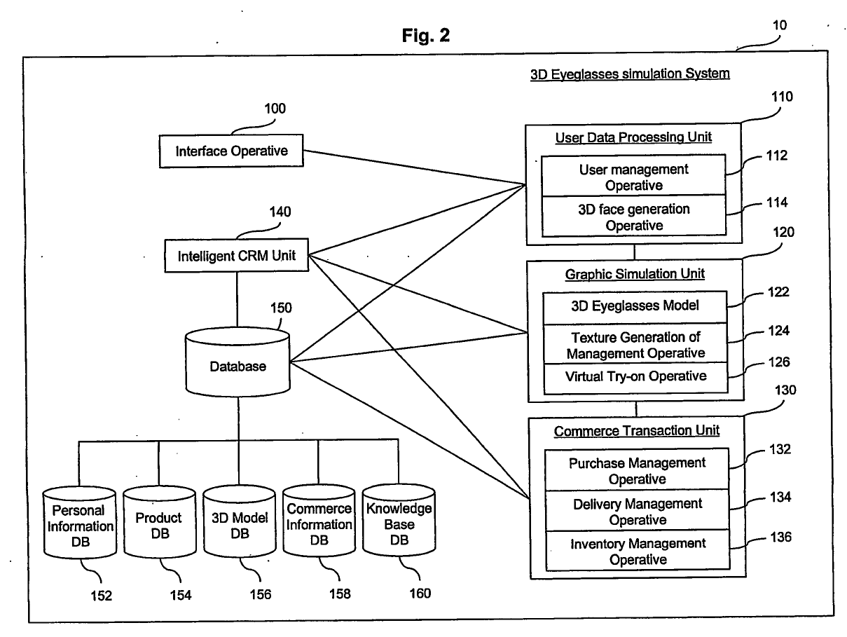

In FIG. 2 overall structure of 3D eyeglasses simulation system (10) is illustrated.

As shown in FIG. 2, 3D eyeglasses simulation system (10) comprises of interface operative (100), data processing unit (110), graphic simulation unit (120), commerce transaction unit (130), intelligent CRM unit (140) and database (150).

The database (150) comprises of user information DB (152), product DB (154), 3D model DB (156), commerce information DB (158) and knowledge base DB (160). Each individual database is correlated each other within the sytem (10). The Interface operative (100) performs communication in between 3D eyeglasses simulation system (10), user (20), eyewear manufacturer (40) and service provider (70). This operative (100) authorizes user information to connect the server and transfers customer purchase history information to the database.

The user data processing unit (110) authorizes user information to connect the server and transfers customer purchase history information to the database. The user management operative (112) verifies the authorized user who is maintained in user information DB (152), and update the user information DB (152) and commerce information DB upon changes in the user profile.

The 3D face model generation operative (114) creates a 3D face model of a user from photo image information provided by the user. The Images can be retrieved by image capturing device connected to user's computer (20), or by uploading user's own facial images with a dedicated facility, or by selecting images among the ones stored in the database (150). This operative accepts one or two images, for front and side view, as input.

The graphic simulation unit (120) provides a facility where the user can select eyeglasses he or she wants, and generate a 3D eyeglasses model for selected eyeglasses, and simulate virtual try-on of eyeglasses with 3D face model generated by the 3D face model generation operative (114). Graphic simulation unit (120) consists of 3D eyeglasses model management operative (122), texture generation operative (124) and virtual try-on operative (126).

The graphic simulation unit (120) also provides a facility where a user can build his or her own design by simulating design, texture and material of eyeglasses together with 3D model generated beforehand. The user can also add a logo or character to build his or own design. This facility enables operation of ‘custom-made’ eyeglasses contents, and the intelligent CRM unit (140) complement this contents by providing highly personalized advice on fashion trend and customer characteristics.

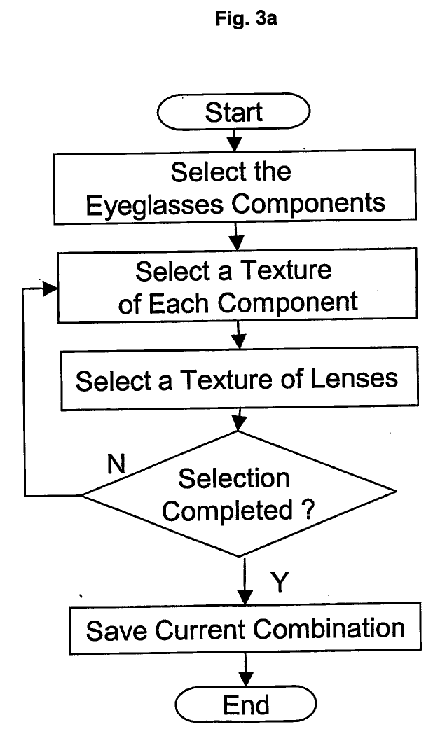

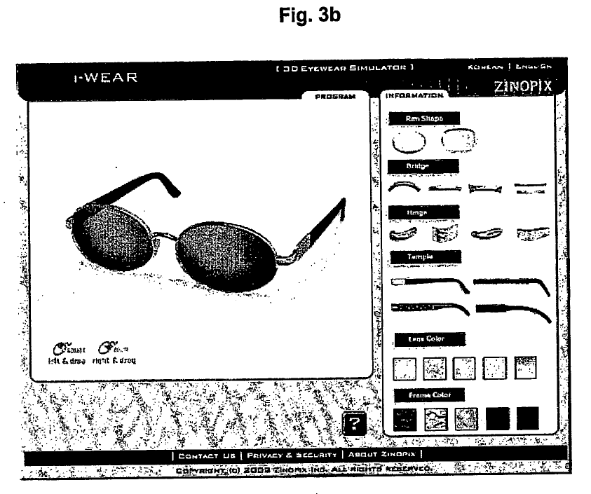

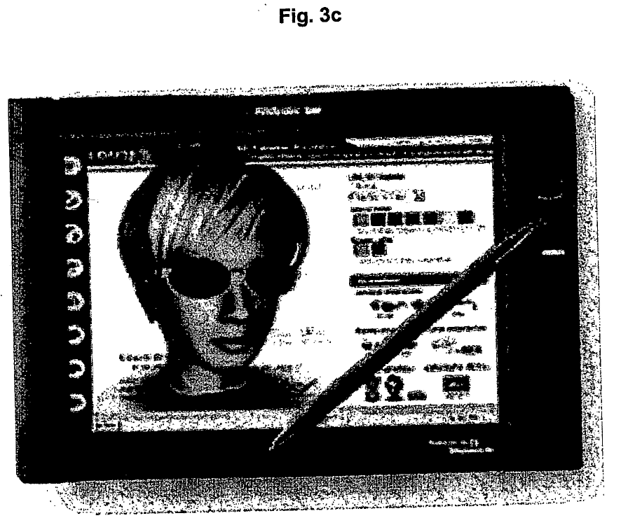

The texture generation management operative (124) provides a facility that a user can select and apply a color or texture of eyeglasses that he or she wants. FIG. 3a illustrates the flow of texture generation process. As shown in FIG. 3b, a user can select a color or texture of each component of the eyeglasses such as frame, nose-pads, bridge, hinge, temples and lenses. The selected model can be rotated, translated, zoomed or animated at real-time as the user operates the mouse pointer.

The commerce transaction unit (130) performs entire merchant process as the user proceeds to purchase eyeglasses product after 3D simulation (10) is done. This unit (130) consists of purchase management operative (132), delivery management operative (134) and inventory management operative (136).

The purchase management operative (132) manages the user data information DB (152) and commerce information DB (158) that maintains the order information such as information about product, customer, price, tax, shipping and delivery.

The delivery management operative (134) provides a facility that verifies the order status, transfers the order information to a shipping company and requests to deliver the product. The inventory management operative (136) manages the inventory information of eyeglasses in 3D eyeglasses simulation system (10) throughout purchase process.

Intelligent CRM unit (140) can learn new trends of customer behavior with fashion trend information provided by experts in fashion and then forecast future trends of fashion from acquired knowledge base effectively.

Detailed description about CRM unit will be further illustrated in chapter 3.

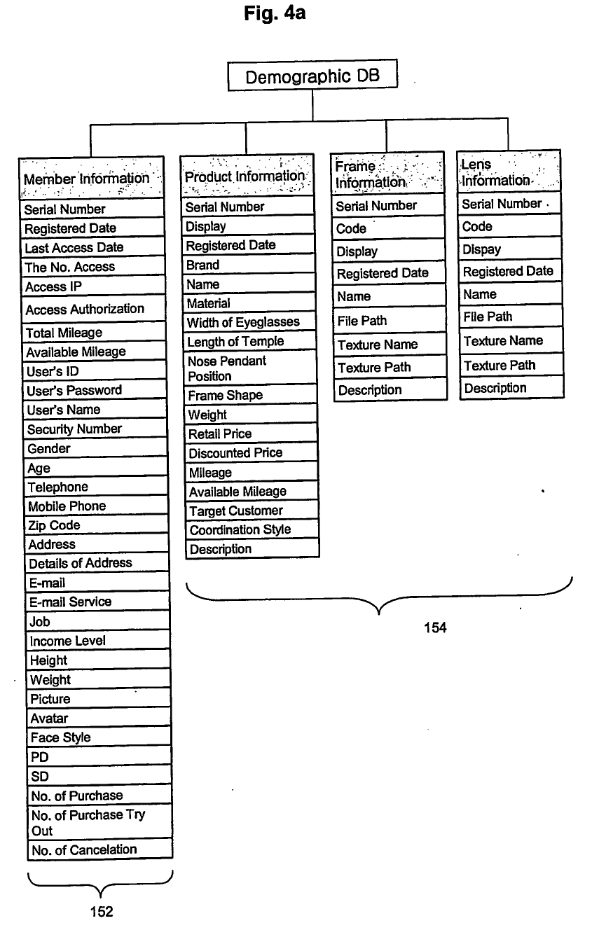

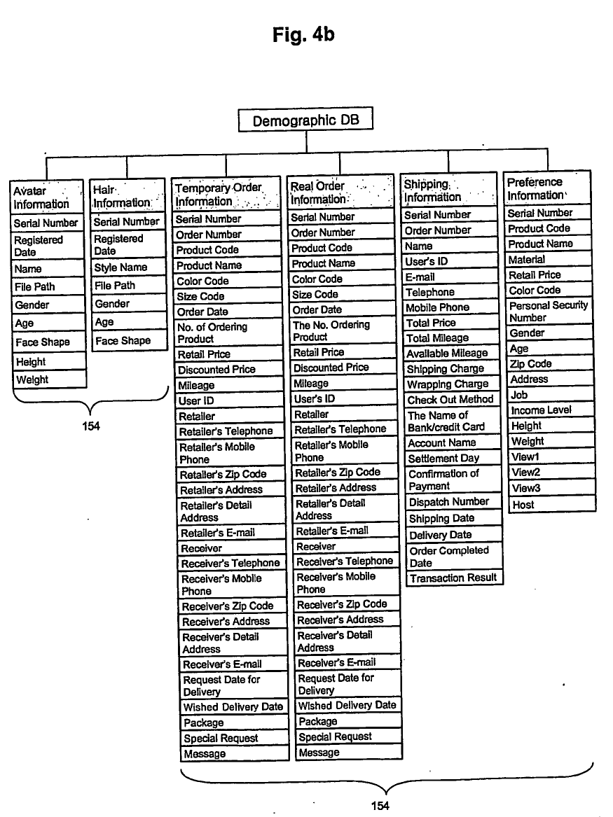

In FIGS. 4a and 4b, detailed database attributes for user information (152) is illustrated.

2. A Method and Facility for 3D Face Model Generation

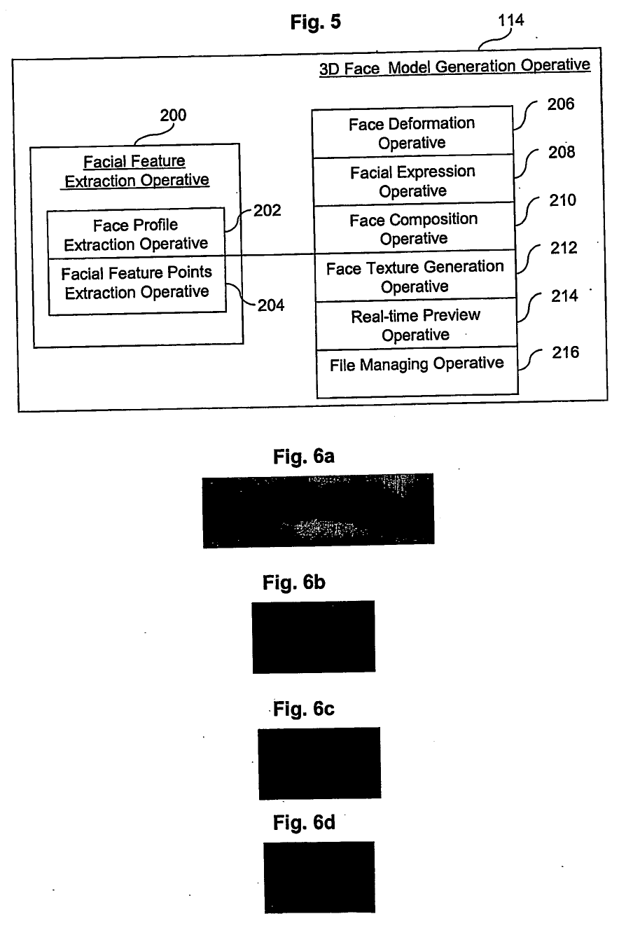

FIG. 5 is detail diagram for the 3D face model generation operative (110) in FIG. 2.

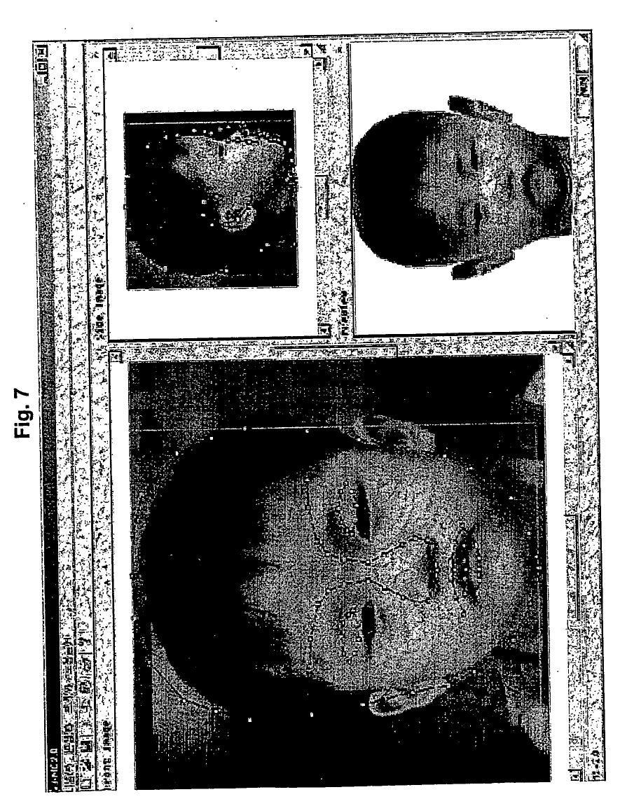

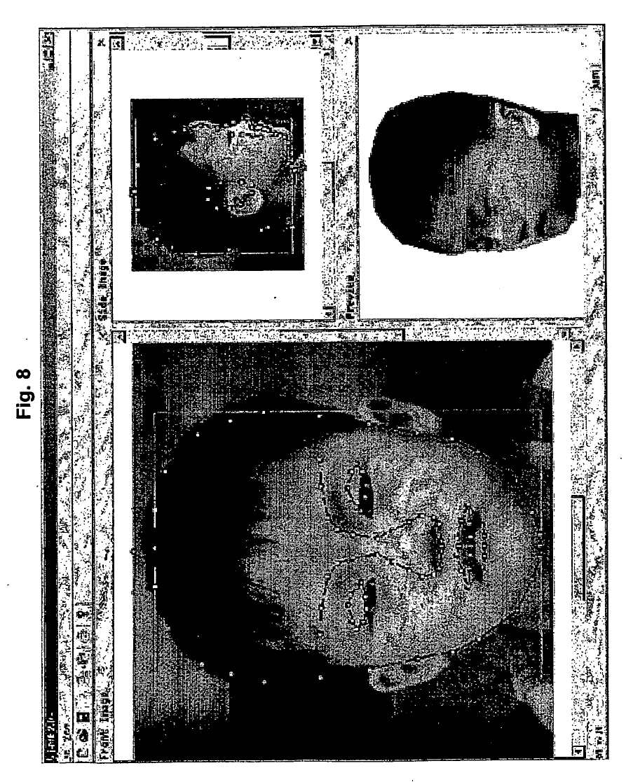

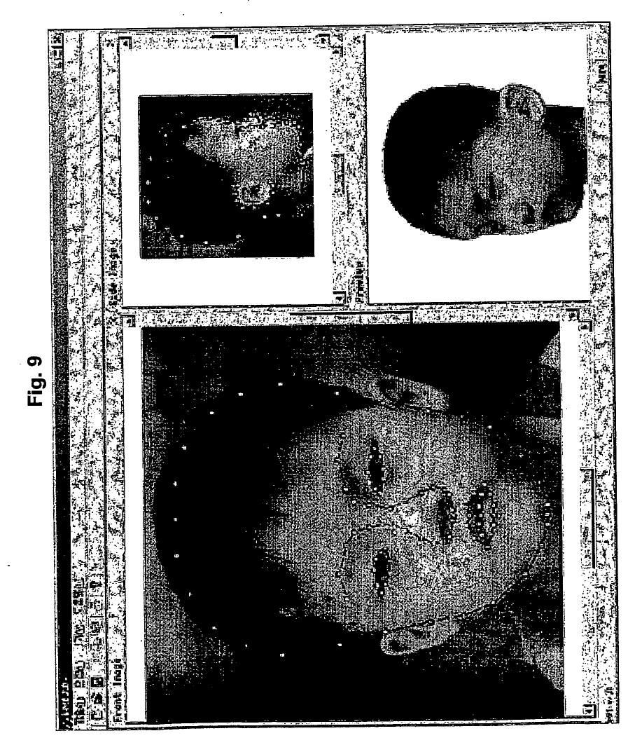

FIG. 6 to FIG. 8 illustrates additional method for 3D face model generation.

From here, a term ‘avatar’ is used to represent a 3D face model that has been generated from photo images of human face. This term covers a 3D face model of a user and default models stored in the database of the system (10).

2-1 3D Face Model Generation Facility

The 3D face model generation operative (14) provides a facility that retrieves image information for 3D model generation and generates a 3D avatar of the user. This operative consists of facial feature extraction operative (200), face deformation operative (206), facial expression operative (208), face composition operative (210), face texture generation operative (212), real-time preview operative (214) and file managing operative (216) as shown in FIG. 4.

The facial feature extraction operative (200) performs extraction of face outline profile, eyes, nose, ears, eyebrows and characteristic part of the face from facial image provided by the user. This operative is consists of face profile extraction operative (202) and facial feature points extraction operative (204). In this paper, face profile points and facial feature points are named as ‘base points’.

The 3D face model generation unit (114) display facial images of a user and retrieve positions of the base points of front and side image by user interaction to generate a 3D face model. Base points are a part of the feature points that govern characteristics of a human face to be retrieved by user interaction. This is typically done by mouse click on base points over retrieved image. The face deformation operative (206) deforms a base 3D face model using the base points positions defined.

The Facial expression operative (208) generates facial expressions of the 3D face model to construct a so-called ‘talking head’ model that simulate the expression of human talking and gestures. The face composition operative (210) generates additional avatars by combining 3D face models of the user with that of others.

The face texture generation operative (212) creates textures for the 3D face model. This operative also creates textures for remaining part of the head model that are unseen in the photo images provided by the user.

The real-time preview operative (214) provides a facility that user can 3D images of face model generated. The user can rotate, move, zoom in and out, and animate the 3D model at-real time. The file managing operative (216) then saves and translates 3D avatar to generic and standard formats to be applied in future process.

The face profile extraction operative (202) extracts outline profile of the face from retrieved positions of the base points. The facial feature points extraction operative (204) extract feature points of the face that are inside of outline profile.

2-2 3D Face Model Generation Method

In FIG. 7 the base points for facial feature that are setup in default positions of the generic face model are illustrated. As the user locate the new positions of base points close to corresponding points of the retrieved image, the system calculate to extract precise position of translated based points from the retrieved image. FIG. 8 shows the feature extraction process by that some of base points have been adjusted to new positions. In FIG. 9, all base points have been adjusted by subsequent process.

From here, detailed mathematical process to extract feature points of the human face from the photo image is described.

Extracting the outline profile of the face (202) is described first. The outline profile of the face stands for a borderline that governs characteristics of a human face. In the face profile extraction operative (202), in order to extract the outline profile, an enhanced snake that added facial texture information on a deformable base snake has been incorporated. The mathematical definition of the snake is a group of points that move toward the direction where the energy, such as light intensity, minimizes from the initial positions.

Preceding snake models had limitations to extract a smooth curve of outline face profile because those models only allowed to move the points toward minimized energy without considering lighting effects. A new snake presented in this invention implemented a new method that considers texture conditions of the facial image and drives the snake to move to where the facial textures are located, namely from outward to inward.

The face profile extraction operative (202) generates the base snake using the base points (Pr) and Bezier curves. The Bezier curve is a mathematical curve to represent an arbitrary shape. An outline profile of the face is constructed by following Bezier curve.

$$Q ( t ) = {\sum }_{r = 0}^{3} ( \begin{matrix}3 \\ r\end{matrix} ) {{t}^{r} ( 1 - t )}^{3 - r} {P}_{r} \\ = {( 1 - t )}^{3} {P}_{0} + 3 {t ( 1 - t )}^{2} {P}_{1} + 3 {t}^{2} ( 1 - t ) {P}_{2} + {t}^{3} {P}_{3} \qquad [ Equation 1 ]$$

Where, r is the number of base points and t is the constant value with range of 0≦t≦1.

The snake defined by above equation is adjusted by following equation by finding the direction where the energy is minimized.
E=ΣαEᵢₙₜ+βEₑₓₜ=Σα|νᵢ−νᵢ₋₁|+β(−∇|I(x,y)|) [Equation 2]

Where, Eᵢₙₜ is internal energy meaning background color, Eₑₓₜ is external energy meaning facial color of texture, α and β are arbitrary constant value, ν is a initial point of the snake, I(x, y) is intensity at point (x, y), ∇I(x, y) is a intensity gradient at point (x, y).

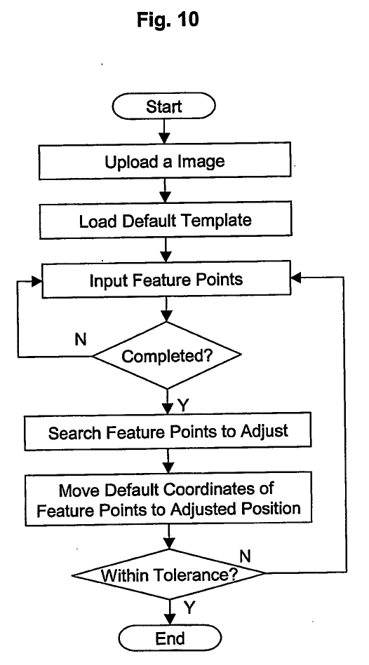

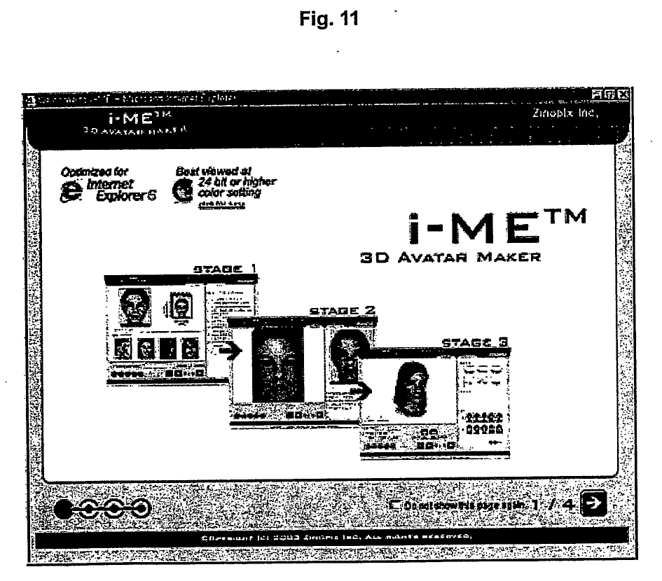

Secondly, an operative to extract facial feature points (204) inside outline profile is described. This operative utilizes a template matching technology that finds the new positions of facial feature points by computing correlation in between predefined template of the facial image and that of retrieved one. In this method, whenever the user defines a new position, the operative trace the information in the neighbor and find adjusted point. FIG. 10 is the flow of the template matching method.

FIG. 6a to FIG. 6d show predefined windows of template for facial feature implemented in this invention is presented.

FIG. 11 to FIG. 14 illustrate a client version of the 3D face generation operative (114) implemented on internet platforms. With this facility the user can generate his or her 3D avatar with one or two images of the face. This facility also can be ported on stand-alone platforms for offline business.

FIG. 11 is the initial screen of the facility. In this screen, a step-by-step introduction for 3D avatar generation is introduced.

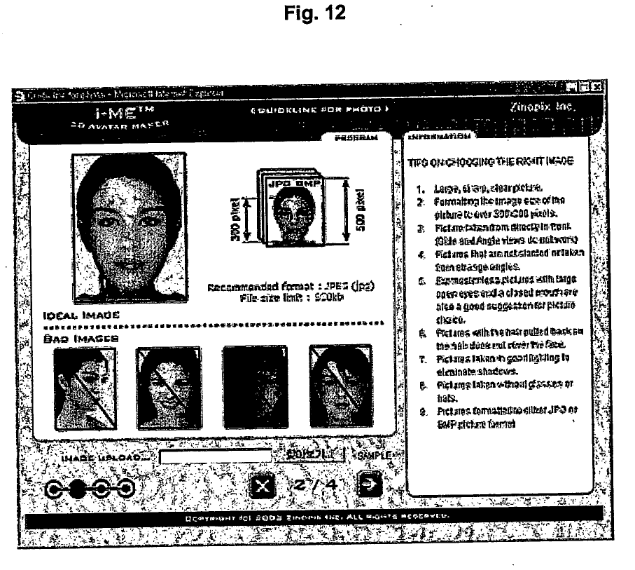

FIG. 12 is the step to input the just one user image. In this step, guidelines for uploading optimal image are illustrated.

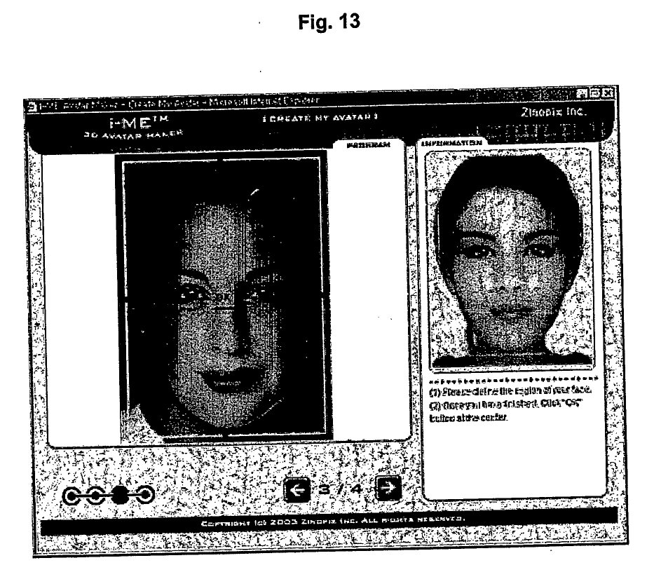

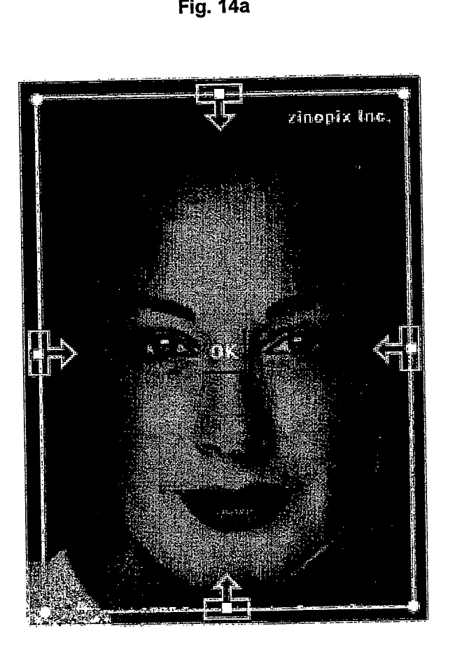

FIG. 13 shows uploaded image by the user.

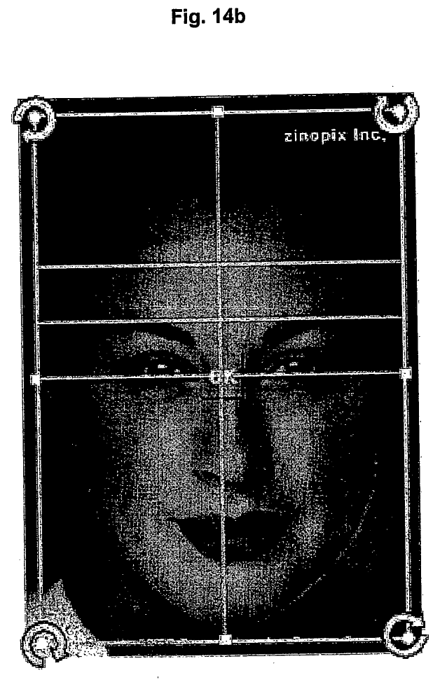

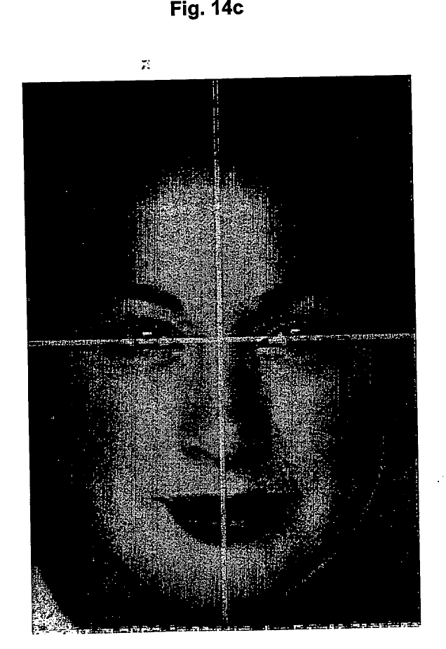

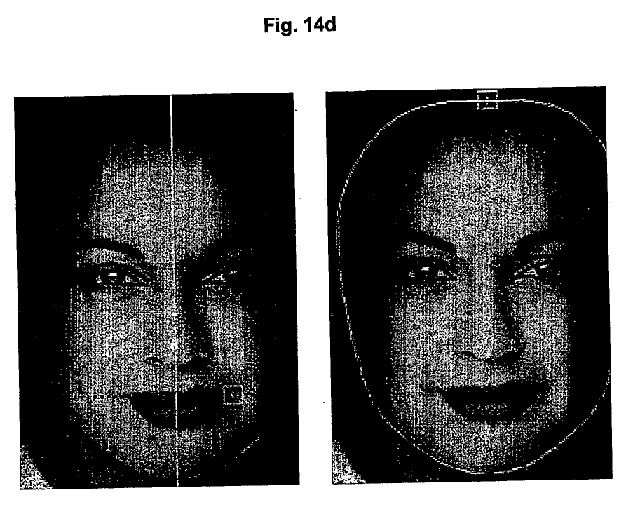

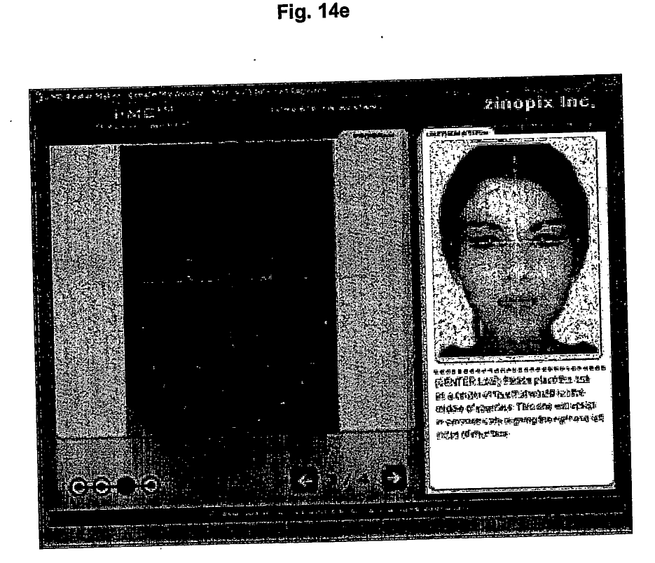

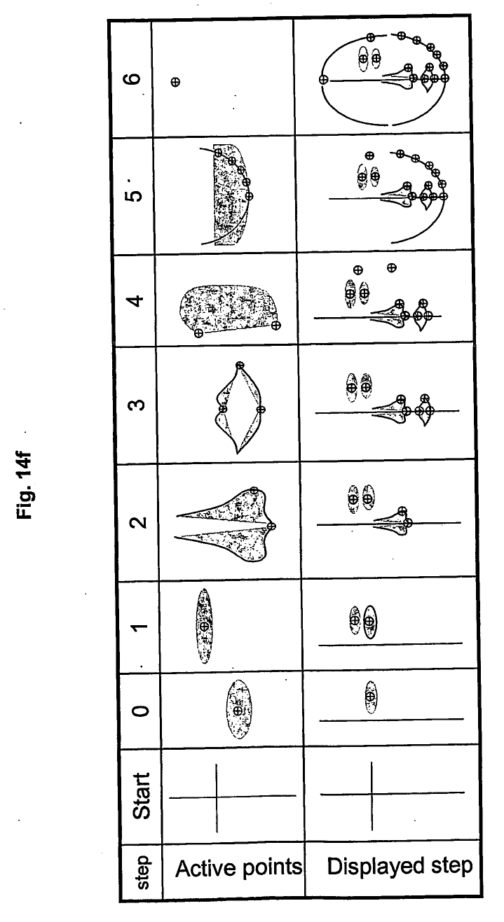

FIG. 14a to FIG. 14c show the step to adjust uploaded image by resizing, rotating and aligning. As shown in FIG. 14d, symmetry of the face has been applied to minimize user interaction.

FIG. 14d shows the step to define feature points of the face by mouse pointer. During this step, as the user defines the points for base feature points in the half part of the face, the operative automatically find corresponding feature points in the remaining part of the face. In addition, as soon as the user defines a position for base feature points, the operative reposition remaining feature points, and prompt adjusted default positions for remaining points.

FIG. 14e shows the result of feature point extraction.

FIG. 14f shows the each step to adjust the feature points by using symmetry of the face. In FIG. 14f, ‘active points’ represent live points to move during the step and ‘displayed as’ represent the acquired points from active step. These steps go through the pupil, eyebrow, nose, lips, ear, jaw, chin, scalp, and outline points. As soon as each step is finished, the next step is automatically calculated.

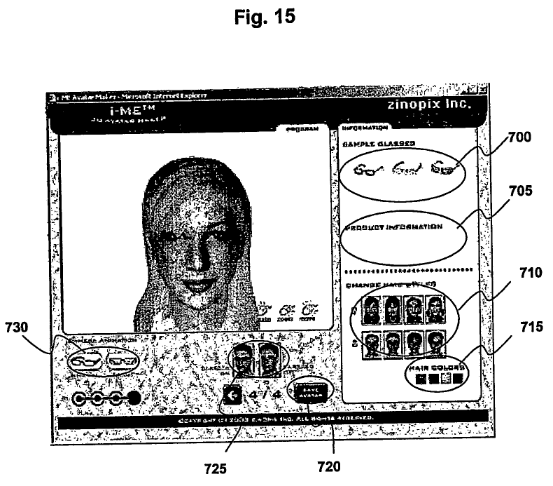

FIG. 15 illustrates an example of the real-time preview operative (214) implemented on the internet platform to visualize the 3D avatar generated by 3D face generation operative (114). This operative provides following facilities.
a) Built-in 3D eyeglasses models (700): Upon selection of each eyeglasses model, virtual-try-on and automatic fitting is performed at real-time
b) Product information display (705): Detailed product description is displayed in text retrieved from product information database (154)
c) Built-in 3D hair models (710): Number of hair models for male and female are maintained by 3D model database (156). Upon selection of each hair model, automatic fitting of the hair and face model is performed at real-time.
d) Built-in texture library for hair models (715): Textures for hair color are provided. Selected hairstyle and color together with the face model is saved as an avatar of the user.
e) Showing and hiding the 3D face model (725)
f) Saving generated 3D avatar with a name. This avatar can be retrieved in the applications where 3D eyeglasses simulation system (10) is implemented.
g) 3D view manipulation (730): 3D models are viewed in predefined view angles and scales for optimal visualization. This is actually prescribed animation of 3D models to locate on the specific position with specific angle. In addition, as the user moves the mouse pointer over the screen, the models can be rotated, moved and zoomed.

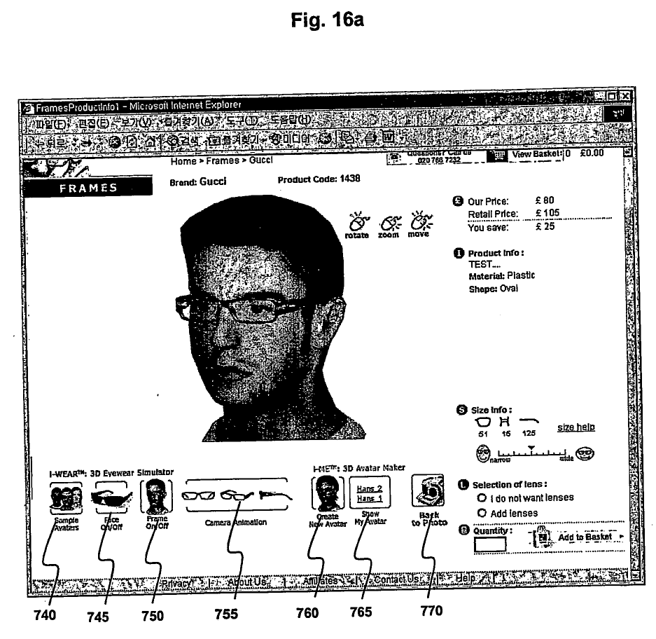

FIG. 16a illustrates an example of 3D eyeglasses simulation system (10) applied on a web browser. A user can get connected to this application service by having an access to internet environment provided by internet service providers (70). This application is served from the web site of a manufacturer or a distributor, or from online shopping malls that have partnership with the manufacturer or the distributor. This application provides following facilities.
a) Built-in sample avatars (740): Upon locating mouse pointer over the icon, number of sample avatars that include different genders, races, ages and types of the face are displayed. The user can perform virtual-try-on with these avatars without having to generate his or her own 3D avatar.
b) Showing and hiding the 3D face model (745)
c) Showing and hiding the 3D eyeglasses model (750)
d) Prescribed animation from different angles (755)
e) Link to 3D face model generation operative (760): Upon selection of this link, 3D face generation and real-time preview operatives illustrated in FIG. 15 are uploaded.
f) Selecting predefined avatar (765): For the user who has registered in the applications where the 3D eyeglasses simulation (10) is implemented, predefined avatars are displayed. The user can select any of listed avatars and proceed to virtual-try-on process.
g) Link to a different page of the application

The 3D avatar applications illustrated in FIG. 15 and FIG. 16a can be extended to other applications that utilize the virtual human model. FIG. 16b illustrates an application for virtual fashion simulation utilizing 3D avatar generated in the present invention. In this example, the 3D avatar is combined with a body model to represent a whole body of a human. With this avatar, not only eyeglasses, but also variety of fashion items such as clothing, hairstyle, jewelry and other accessories is simulated in similar manner.

From here, detailed mathematical process for the deformation of 3D face model (206) is described.

The face deformation operative (206) implemented two methods for face deformation as follows. First method is the ‘DFFD’ (Dirichlet Free-Form Deformation) technology to determine overall size and characteristics of a human face. Second method is to use a ‘moving factor’ driven in the present invention for precise control of detailed features of a human face.

Firstly, DFFD is an extended formula of FFD (Free-Form Deformation) method. In FFD method, base points should be located on rectangular lattice. In DFFD method, there is no such limitation and arbitrary points can be used as base points. Thus, DFFD can use any points on the face model for base points for facial feature.

In DFFD method, assuming P as set of all base points and P₀ as set of all points on the face, Sibson coordinate for group of points (Qₖ) is calculated, where Qₖ is the neighbors of p in P for all points p in P₀. An arbitrary point p is calculated by linear combination of neighbors pᵢ contributing to p. That is, an arbitrary point p is obtained by a linear summation of several points on featured shape. For example, let P₁, P₂, P₃, P₄ are arbitrary points in the convex hull of given points, p surrounded by P₁, P₂, P₃, P₄ can be defined as p=u₁P₁+u₂P₂+u₃P₃+u₄P₄, where uᵢ is called Sibson coordinate of P₁, P₂, P₃, P₄ and defined as follow.

$$p = {\sum }_{i = 0}^{n} {u}_{i} {P}_{i} \qquad [ Equation 3 ]$$

where,

$${\sum }_{i = 0}^{n} {u}_{i} = 1 ,$$

and uᵢ>0 for any i in [0,n].

If one of the neighbors set Qₖ are moved by user, amount of movement, Δp₀ is obtained by following equation.

$$Δ {p}_{0} = {\sum }_{t = 0}^{k} Δ {P}_{i} {u}_{i} \qquad [ Equation 4 ]$$

where, k is the number of neighbors, ΔPᵢ is the amount of base point moved. Thus, new position of p₀ is calculated by p₀′=p₀+Δp₀.

Secondly, a moving factor method developed in the present invention is described. In this method, when an arbitrary point p∈P moves by Δp, other points p₀∈P₀, analogous to p, move with a moving factor σ. The moving factor σ is a constant value defined in a base point and other points that are analogous to the base point. Since p₀'s movement is similar to that of p, the movement of the p₀ is obtained by σ·Δp. Likewise, once the moving factor is determined, new positions of all of the base points that are analogues can be computed.

With the technology described in this chapter, a realistic 3D face model is obtained by one or two photo images of a human face.

The facial expression operative (208) deforms 3D mesh of the face model to represent detailed expression of human face. This operative also deforms corresponding texture map to get a realistic expression.

A term ‘polygon’ means a three dimensional polygonal object used in three dimensional computer graphics. The more polygons are used, the higher quality of 3D image is obtained. Since a polygon is a geometrical entity, there is no information for color or texture in this entity. By applying texture mapping to a polygon, more realistic 3D model is obtained.

To deform a polygonal model of the 3D face to generate a facial expression, a light intensity (I) is to be calculated as shown in following equation for arbitrary point p on the polygon of the face model by Rambert model.

$$I = ρ {\sum }_{i = 1}^{m} {I}_{i} n \cdot {l}_{i} \qquad [ Equation 5 ]$$

where, ρ is a reflection coefficient, I₁ is a light intensity, lᵢ is a direction to light source, m is the number of spot light and n is the normal vector at point p.

Then, the light intensity (I′) for updated polygon is obtained by following equation.

$${I}^{′} = ρ {\sum }_{i = 1}^{m} {I}_{i} {n}^{′} \cdot {l}_{i}^{′} \qquad [ Equation 6 ]$$

where, n′ and lₗ′ is normal vector and light intensity respectively on updated polygon.

From equation 5 and equation 6, ERI (Expression Ratio Intensity) of the surface of the face is obtained by following equation.

$$R = \frac{{I}^{′}}{I} = \frac{{\sum }_{i = 1}^{m} {I}_{i} {n}^{′} \cdot {l}_{i}^{′}}{{\sum }_{i = 1}^{m} {I}_{i} n \cdot {l}_{i}} \qquad [ Equation 7 ]$$

where, R is the ERI value of the surface of 3D face model.

The ERI value obtained by above procedure is applied to warp polygons of unexpressed facial model to generate a facial expression.

The face composition operative (210) is generates a new avatar from the generated 3D face model by using the face composition process. Given an arbitrary face data Fᵢ={Fᵢ₀, Fᵢ₁, . . . , Fᵢₙ} and Fⱼ={Fⱼ₀, Fⱼ₁, . . . , Fⱼₙ} have a same polygon structure, corresponding feature points

$${jm}_{}$$

for specific point

$${im}_{} = ( {x}_{im ,} {y}_{im} , {z}_{im} , {r}_{im} , {g}_{im} , {b}_{im} ∈ {F}_{i}$$

exist. A new face model F′ is obtained by combining the face Fᵢ and Fⱼ, namely F′=αFᵢ+βFⱼ where, α and β is the ratio for facial similarity and (α+β=1).

The face texture generation operative (212) generates Cartesian coordinates of the 3D face model and generates texture coordinates of the front and side image of the face. This operative extracts a border of two images and projects the border onto the front and side views to generate textures near the border, and blend textures from two views by referencing acquired texture on the border. Besides, this operative generate remaining texture of head model that is unseen by the photo images provided by the user.

3. Intelligent CRM (Customer Relation Management) Unit

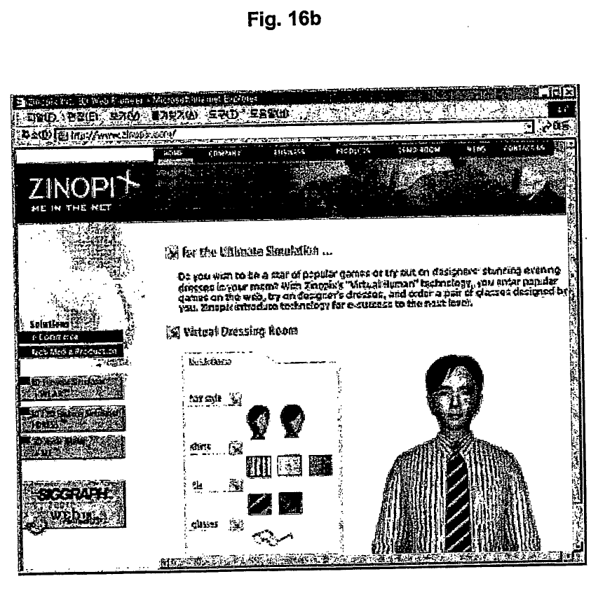

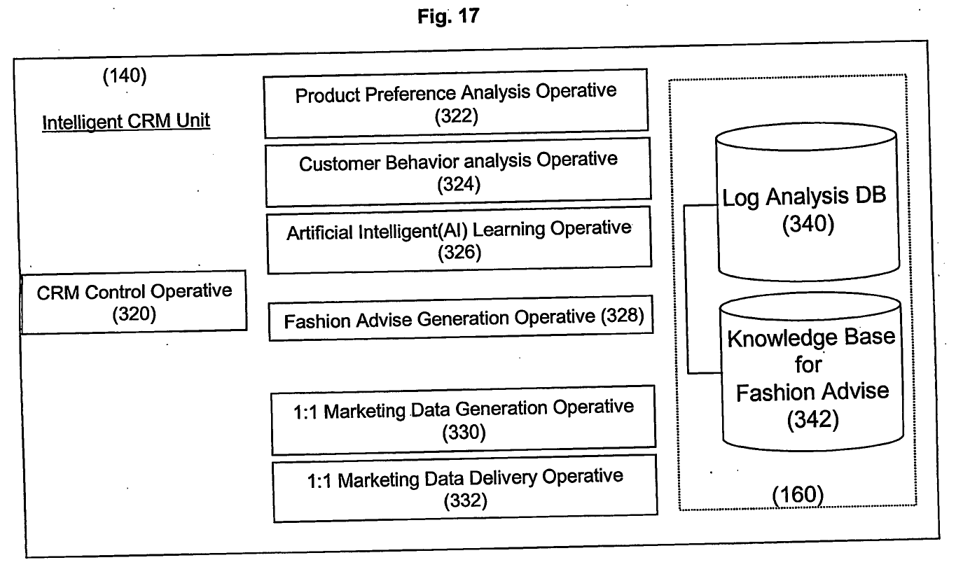

In FIG. 17, a schematic diagram for the intelligent CRM unit implemented in 3D eyeglasses simulation system (10) is illustrated.

As shown in the figure, CRM unit (140 is consist of a product preference analysis operative (322), a customer behavior analysis operative (324), an artificial intelligent learning operative (326), a fashion advise generation operative (328), an 1:1 marketing data generation operative (330), an 1:1 marketing data delivery operative (332), a log analysis database (340) and a knowledge base for fashion advise (342).

The operative for product preference (322) analyzes the demographic information of a user, such as age, gender, profession and race, and environmental information, such as the name of internet service provider, connection speed and type of telecommunication device, for a certain type or category of eyeglasses product. This result constructs a raw data for knowledge base incorporated in the system (10).

The operative for analysis of customer behavior (324) analyzes the characteristics of a user's action on commerce contents collected form log analysis database (340), and to store the analysis result on knowledge base (342). The log analysis database (340) collects wide range of information about the user behavior such as online connection path, click rate on a page or a product, site traffic and response to promotion campaign.

The operative for artificial intelligent learning (326) integrates analysis for product preference and customer behavior with fashion trend information provided by experts in fashion, and construct raw data for advising service dedicated to a customer.

The 1:1 marketing operative consists of the 1:1 marketing data generation operative (330) to acquire and manage demographic information of the user including email address or phone numbers and to publish promotional contents using 3D simulative features and the 1:1 marketing data delivery operative (332) to deliver promotional contents to the multiple telecommunication form factors of the customer. The promotional contents are published in proper data formats, such as image, web3D, VRML, Flash, animation or similar rich media contents formats, to be loaded on different types of communication devices.

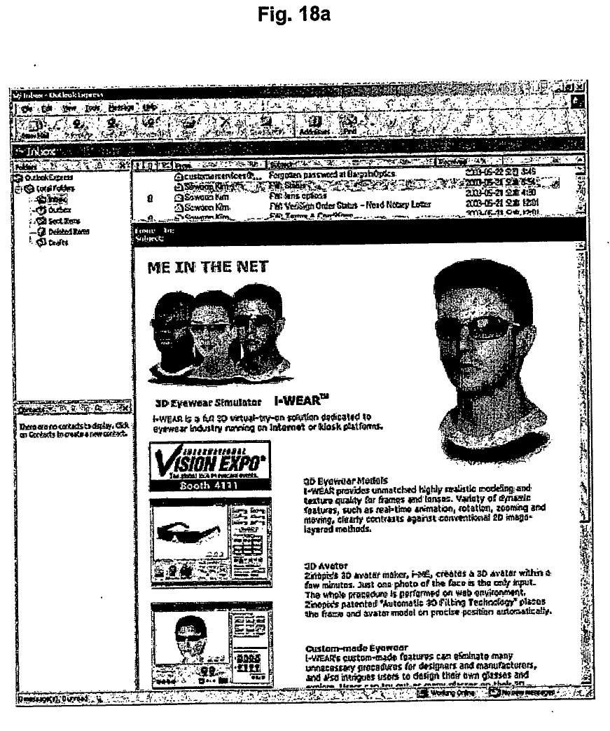

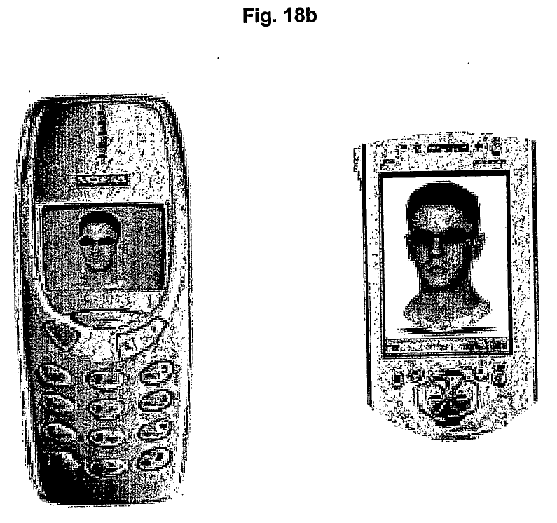

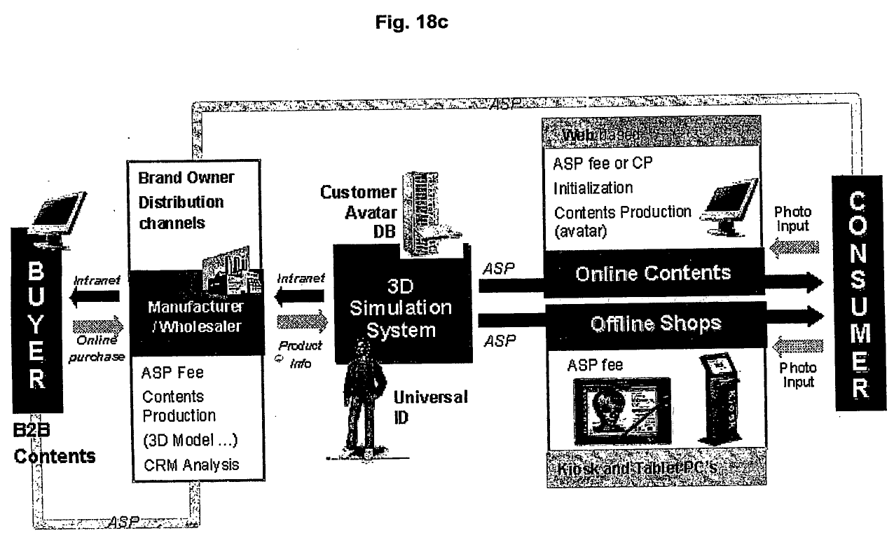

Above marketing operative (330, 332) keep track of customer response and record it in log analysis database (340). This response are forwarded to the operatives for product preference (322) and customer behavior analysis (324) to generate analysis on response history of product preference, seasonal effect, promotion media, campaign management, price and etc. Analyzed result is provided to the manufacturer or the seller and applied as base information to design future product to setup sales strategy. In FIG. 18a and FIG. 18b, examples of 1:1 marketing are illustrated.

In order to publish 1:1 marketing contents, a face model of the user is required. This model is obtained by following cases. Firstly, a user can upload his or her own image onto the online applications where 3D eyeglass simulation system (10) is implemented. Secondly, an optician or a seller take a photograph of the user when he or she visited offline show room and register the image on customer's behalf. Uploaded images acquired above sequence is stored and maintained in 3D simulation application server.

By running CRM analysis in early stage of production cycle through communication with potential customers, a manufacturer or a seller can improve customer satisfaction by incorporating the response acquired from the analysis. This process optimizes production and distribution process of eyeglasses. The information generated during this process can be utilized as decision support material on B2C or B2B business of eyeglasses complemented by electronic catalogue or similar 3D virtual-try-on contents published in 1:1 marketing process.

The operatives illustrated in this chapter are managed by the CRM unit (140) in FIG. 17 and FIG. 2.

The CRM unit (140) can provide quantified data for future forecast of product sales and trend, and can provide advice to a customer dedicated to his or her own preference by extensive analysis on response analysis. This unit also provides contents for custom-made eyeglasses with dedicated assistance for fashion trend and the characteristics of the user profile.

The parameters that govern tendency and preference on a product can be summarized as below.

TABLE 1
Demographic parameters for CRM unit

| Parameters for an Avatar | Parameters for a Customer |
|---|---|
| Shape of the face | Race |
| Width and length of the face | Age |
| Skin tone | Gender |
| Lighting for the face | Visual power |
| PD in 3D model | Address, Country |
| Mouth size | Profession |
| Location of the Eyebrow | Actual PD |
| Hair style | Purchase preference |
| Color of the hair | |
| Preference setup | |

Above parameters are used to obtain following object functions to evaluate customer preference on eyeglasses products.

TABLE 2
Object functions for product preference analysis

| Arguments | Analysis objects |
|---|---|
| Size of eyeglasses | Seasonal effect |
| Shape of eyeglasses | Campaign effect |
| Brand/Manufacturer | Geographical effect |
| Distributor/Seller | Design trend |
| Materials | Purchase trend |
| Color/Pattern for frame | Preference by face width/shape |
| Colon/Pattern for lenses | Preference by race/gender |
| Country of origin | Preference by profession |
| Price | Preference by hair style |
| Model year | Preference by pricing |

4. A Method and System for 3-Dimensional Modeling of Eyeglasses

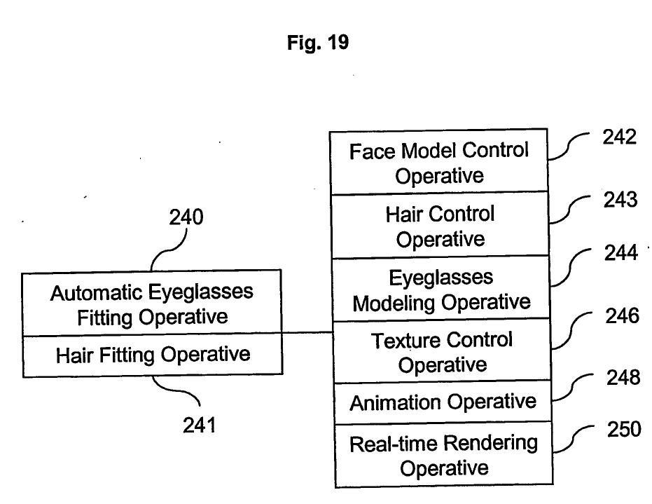

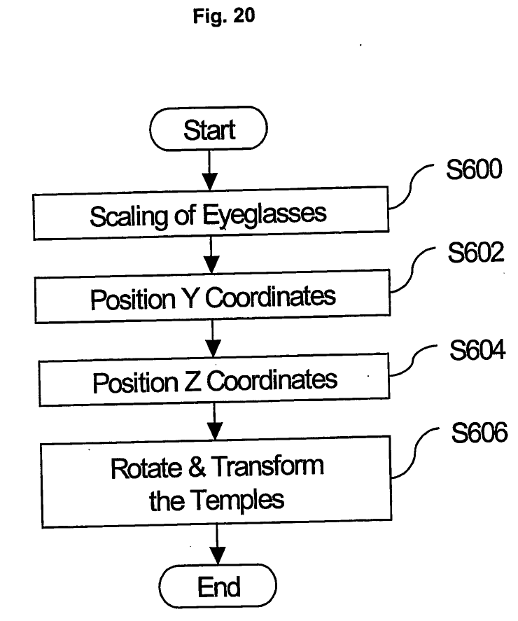

FIG. 19 shows the diagram for the operative to manage 3D eyeglasses model and FIG. 20 is the flow chart for automatic fitting of 3D eyeglasses and 3D face model.

As shown in FIG. 19, the operative to manage 3D eyeglasses model provides a facility to try 3D eyeglasses model virtually on the generated 3D face model and to simulate designs of the eyeglasses product comprises automatic eyeglasses model fitting operative (240), hair fitting operative (241), face model control operative (242), hair control operative (243), eyeglasses modeling operative (244), texture control operative (246), animation operative (248) and real-time rendering operative (250).

The automatic eyeglasses model fitting operative (240) fits the model generated from 3D face model generation operative (14) with 3D eyeglasses model, and its detailed flow is illustrated in FIG. 20 that shows the flow chart for automatic fitting of 3D eyeglasses and 3D face model.

The automatic eyeglasses model fitting operative (240) uses coordinates of the three points on the 3D mesh of eyeglasses and face as input respectively with parameters for automatic fitting. These parameters are used to deform 3D eyeglasses model for virtual-try-on. The fitting process is performed by following procedure. Firstly, the operative calculates scales and positions with parameters of 3D eyeglasses and corresponding parameters of the 3D face model (S600). Secondly, reposition the 3D eyeglasses model by transforming Y and Z coordinates of the model (S602,S604). Finally, rotate the 3D eyeglasses model in X-Z and Y-Z plane to place the temple part of the model to hang on to the ear part of the 3D face model.

4-1 A device for 3D Reverse Modeling of Eyeglasses

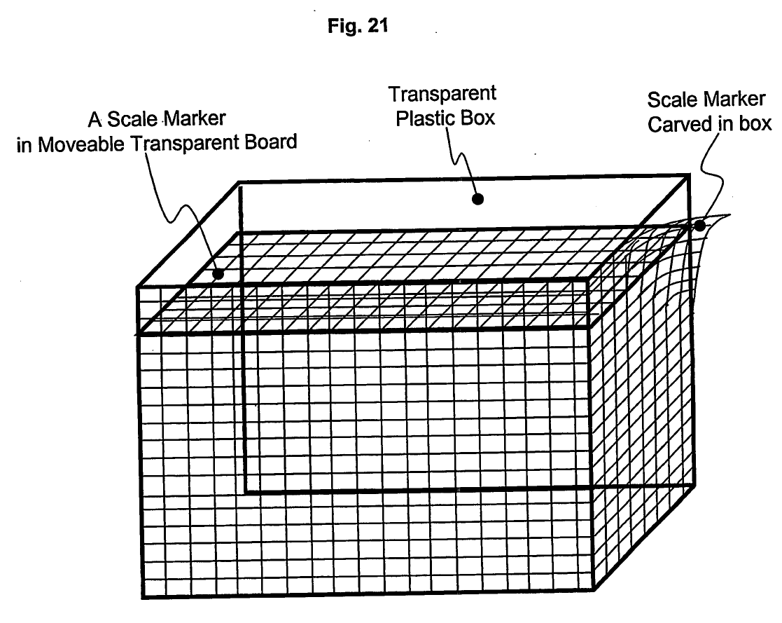

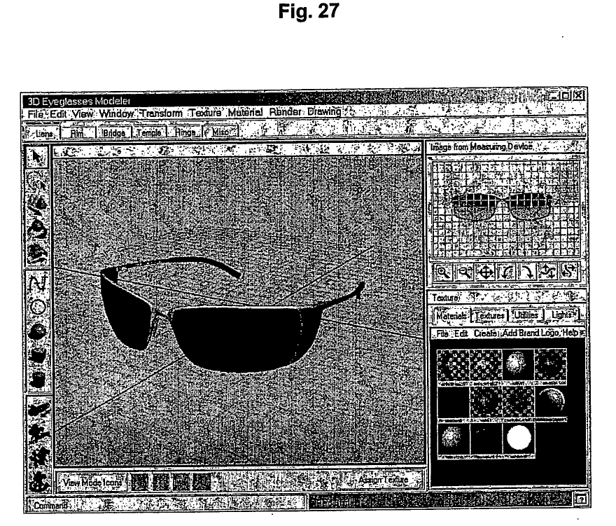

For realistic simulation for 3D eyeglasses, precise modeling of the eyeglasses is very important. In the present invention, a systematic reverse modeling operative that consists of dedicated software for eyeglasses modeling and a specially designed measuring device is developed. With this modeling system, a precise model is generated by duplicating the sequence of eyeglass design. 3D eyeglasses model generated by this method has of great value because vast majority eyeglasses products do not have such information in digital format. Therefore, the developed measuring device provides a systematic procedure to enable reverse modeling method. This procedure is illustrated in FIG. 21 and FIG. 27.

Reverse modeling procedure consists of following five steps.

1) Generating Images Using a Measuring Device:

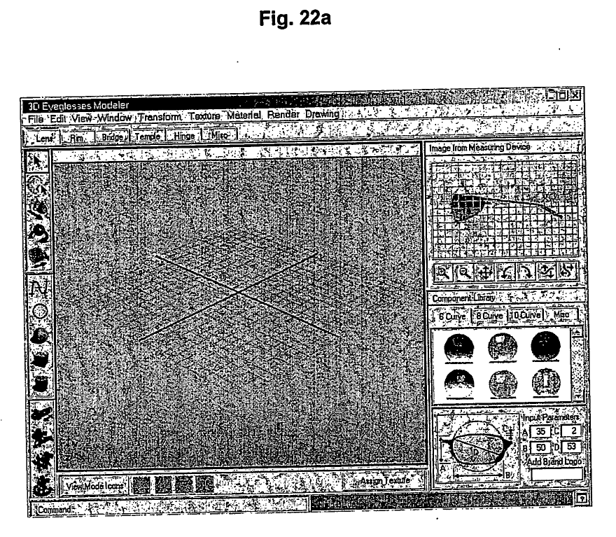

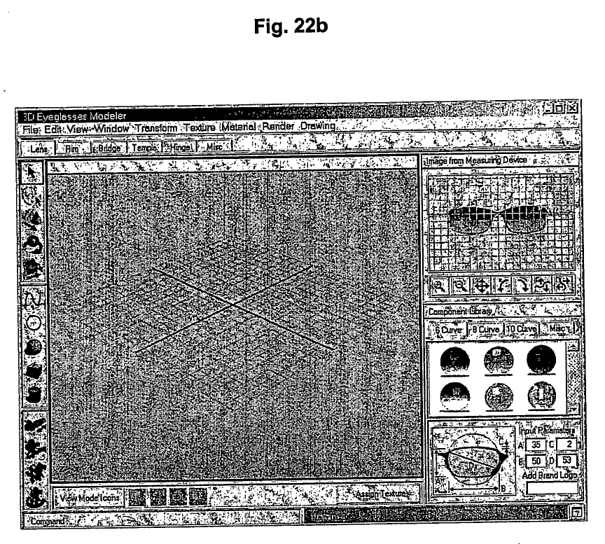

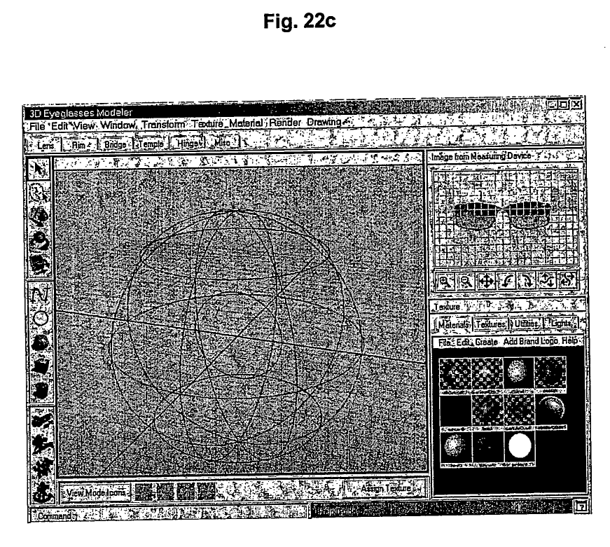

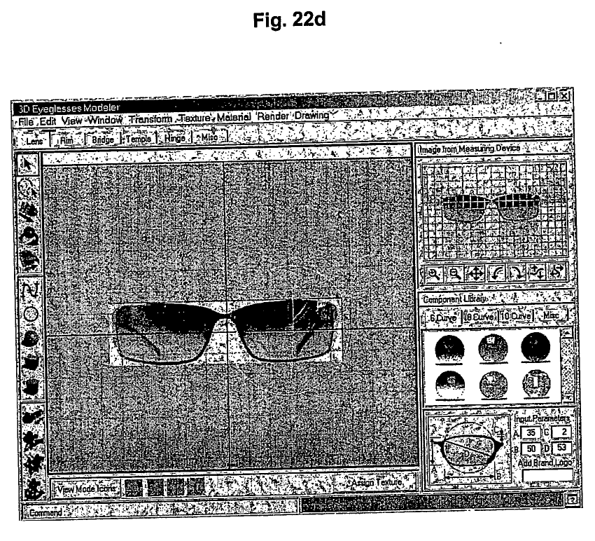

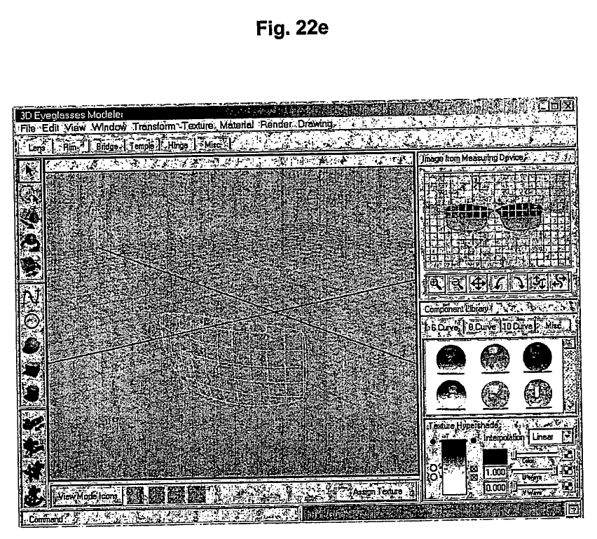

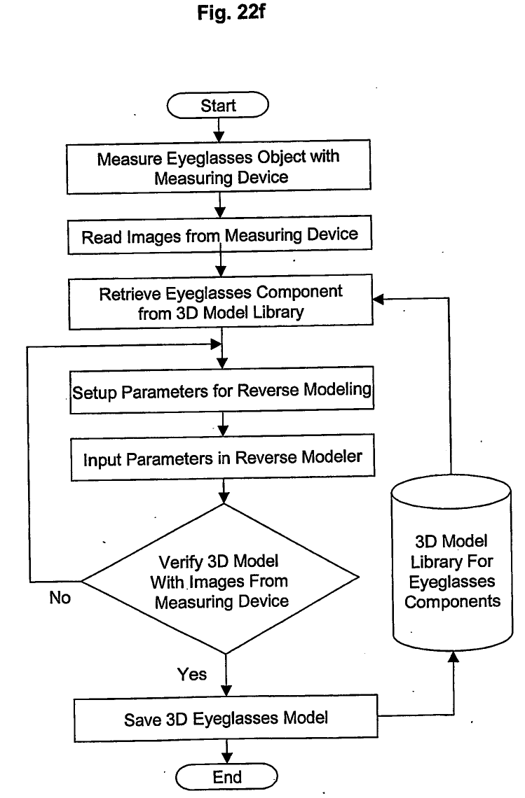

The measuring device is made out of a transparent acryl box where rulers are carved in horizontal and vertical direction as shown in FIG. 21. Placing eyeglasses inside the box, photographic images are taken from the front and side view with the measurement for real dimensions of eyeglasses. Top cover can be elevated upward and downward, so that it helps to take image in precise dimension. Photographic images taken from the measuring device are imported to reverse modeler as shown in FIG. 22a and FIG. 22b.

As shown in FIG. 22b, photographic images with lattice in it preserves dimension for eyeglasses reverse modeling. Photographic image and real dimension data acquired from the device are inputted to 3D eyeglasses model generation operative (244) shown in FIG. 19, by that shape and texture eyeglasses is generated as shown in FIG. 27. FIG. 27 is an image of 3D eyeglasses model, generated by the operative as shown in FIG. 22a and FIG. 22b, retrieved from general-purpose 3D modeling software. The model generated in above procedure is refined with remaining parts selected from built-in library of 3D models and adjusted by provided parameters for each component.

3D reverse modeling operative stores measured information, connects completed 3D eyeglasses model to the database of 3D eyeglasses simulation system, and maintain its information upon each update of the system. FIG. 22f shows overall flow for reverse modeling process.

2) Generating Lens Parts:

In general, surface powers of typical lens ranges from 0 to 10, majority of the products in the market are any of 6, 8, or 10. These are simply called ‘Curve 6’, ‘Curve 8’ and ‘Curve 10’. The higher the curve number is, the smaller the radius of the curvature is. High curved model is typically used for goggle type of eyeglasses. Lens curve is known from the specification of eyeglasses.

Assuming only commercial products are to be modeled, the curve number of the lens can be decided by choosing discrete numbers between 6 to 10. Based on photograph information acquired from measuring device and specification of the lens, the curvature of the lens can be easily obtained. For normal prescription spectacles, the lens curve does not go over curve 6. The radii of the curvature for a specific curve number differ by the optical property of the lens. This property is a constant value that depends on the material of the lens. Optical property with respect to different types of material is known as industry standard. For instance, the radius of curvature for a curve 6 lens with CR-39 plastic is 83.0 mm.

When the radius of the curvature is decided, a sphere is made to start modeling of the lens. Firstly, a lens curve corresponding ED value should be created, where ED is the distance between far end parts of the lens. Creating a circle according to the ED value and project it horizontally to the sphere that is already made will complete lens curve generation as shown in FIG. 22c. Secondly, from the projected sphere, a part for lens curve is extracted by trimming. Thirdly, duplicate the surface using the front view image and modifying the shape by creating another circle vertically as shown in FIG. 22d. Using the circle extracted from lens shape, lens model is finally generated by projecting the circle horizontally to the lens curve and trimming it as shown in FIG. 22e. Normally thickness of the lens is about 1˜2 mm, so the thickness is assumed to be in such range in the modeling.

As an alternative to above procedure, an extensive library of lens model with respect to different curvature is provided by built-in library. By adjusting parameters to match acquired dimension from the measuring device, lens modeling can be readily performed. This technique is efficient for regular spectacles, while previous technique is efficient for complex models.

Once the lens shape is generated, it is rotated by average of 6 degrees downwards to have a parallel slope with anthropometrical structure of human's eye. From the top view, it can be seen that the lens of the eyeglasses is rotated in Y-direction. Therefore, lens should be rotated by 6 degrees in X and Y-direction appropriate to the actual eyeglasses. For Y-direction, rotation differs from model to model by its nature of the design. Value of Y-direction for common prescription eyeglasses is limited approximately to 10 degrees while fashion eyeglasses or sunglasses are to 15˜25 degrees. Once lens generation is completed this step will form a basis to create the frame model.

3) Generating Rim and Bridge Parts:

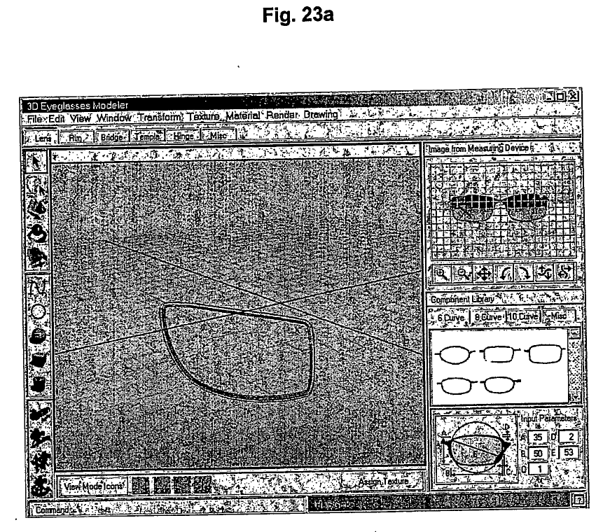

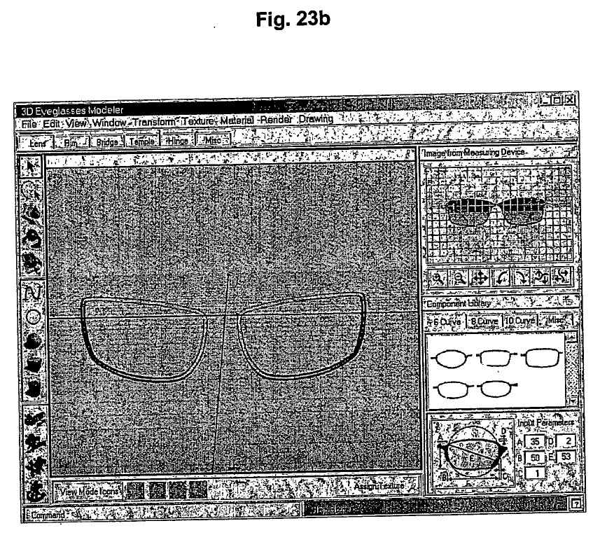

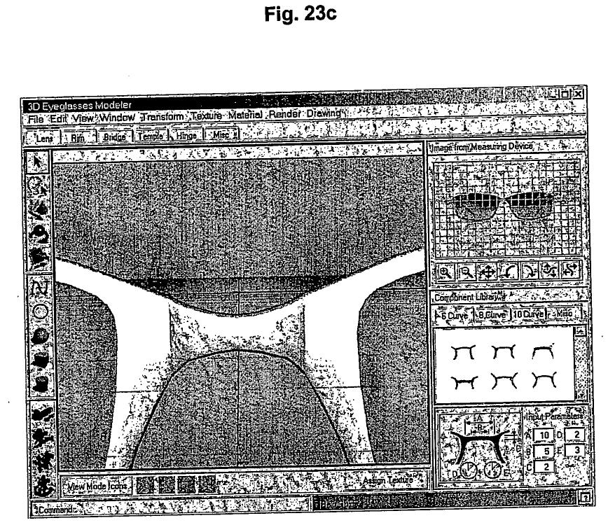

As the frame has the same radius of curvature as that of lens, its curvature is predetermined. First step of frame modeling is to generate a rim that surrounds the lens as shown in FIG. 23a. For rimless eyeglasses, this step is not necessary. The thickness of the frame in the rim can be easily obtained by choosing industry standard values or by measuring devices.

As in lens modeling, an extensive library of rim model with respect to different curvature is provided by built-in library with parameters to adjust the models to match the image acquired from the measuring device.

By its nature of symmetry in a frame with respect to center of eyeglasses, remaining models for the other lens and rim is generated by mirroring the model created in previous process as shown in FIG. 23b. The distance between a pair of lenses is obtained from size specification of eyeglasses.

Rest of the process is to connect a pair of lenses by a bridge model. Since the bridge is not designed for optical purpose, its shape is designed by artistic perspective as shown in FIG. 23c. Consequently, a built-in library of 3D model for the bridge part is provide to be used as a template for the specific bridge model that connects generated a pair of lens and the frame part.

4) Generation a Temple Part:

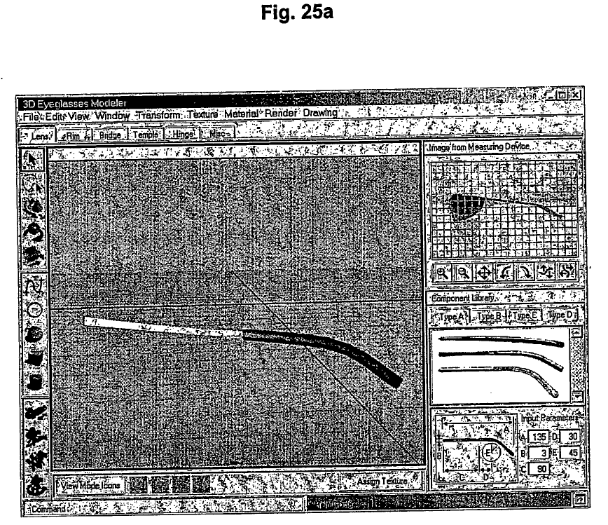

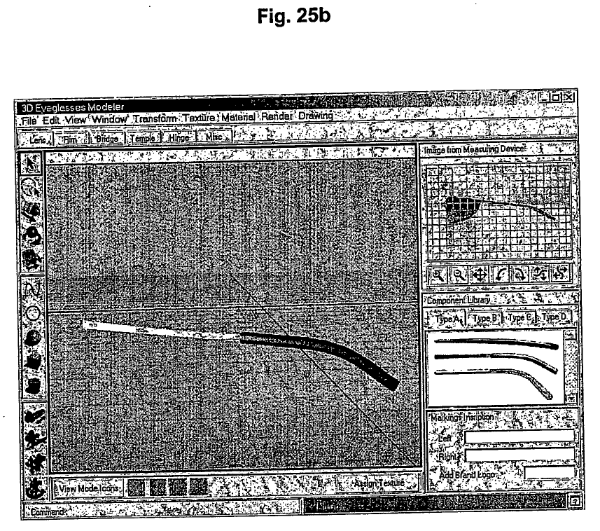

As a temple was designed to fit average size of human head, its length and curvature are also predetermined as industry standards. By using the measuring device or choosing typical discrete design value, thickness of the temple is obtained. Meanwhile, there are some models that have longitudinal curves along the length of the temple. By analyzing the coordinates of grid points acquired from the measuring device, this curve is to be obtained as shown in FIG. 25a and FIG. 25b.

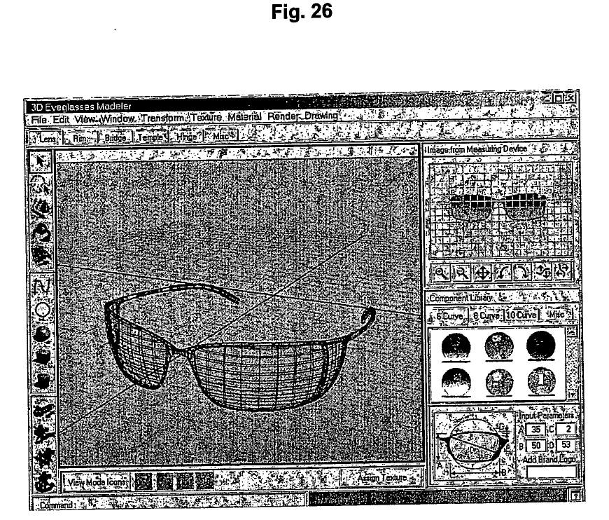

Once a temple model is done, the remaining temple is generated by mirroring the model created in above process. This process is identical to process to generate a pair of lens model. This procedure is illustrated in FIG. 26. As in lens and rim modeling, a library of temple model is provided by built-in library with parameters to adjust the models to match the image acquired from the measuring device.

5) Completing Eyeglasses Model:

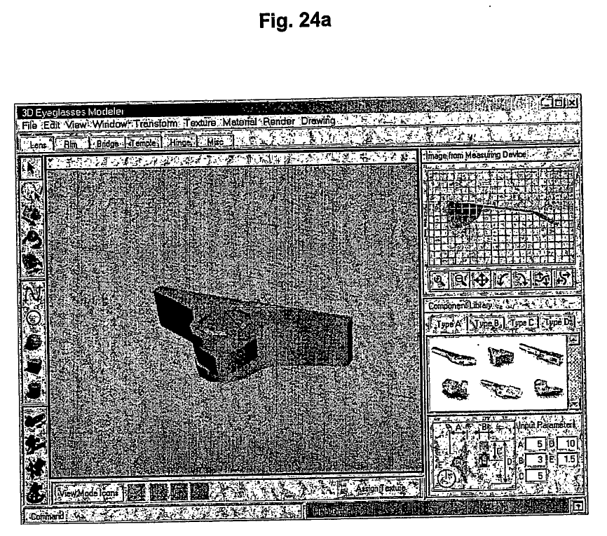

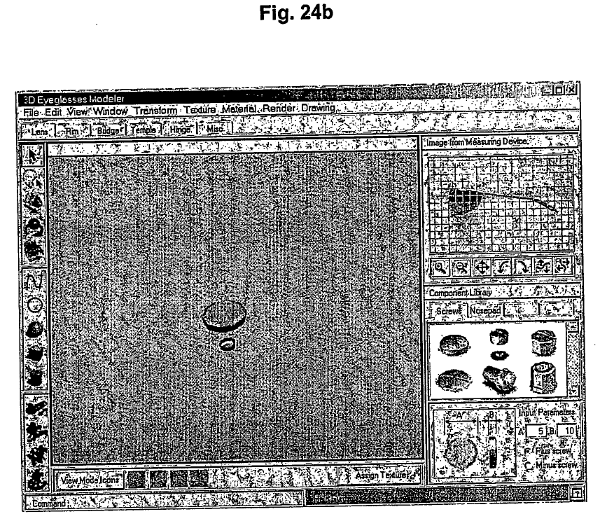

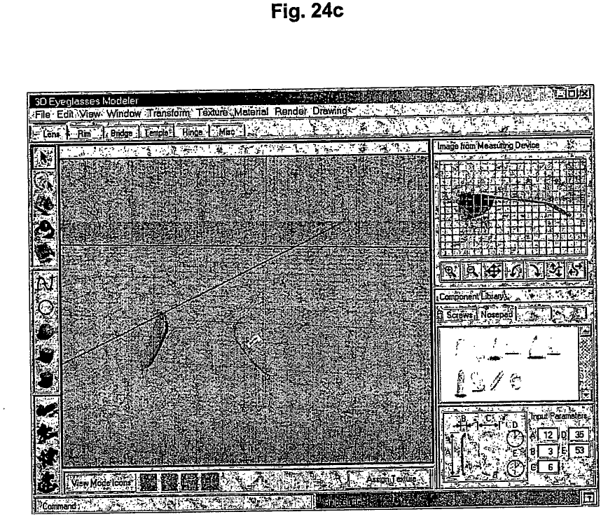

Remaining parts of eyeglasses model such as nose pads, hinges and screws are done by selecting 3D model components from built-in library as shown in FIG. 24a, FIG. 24b and FIG. 24c. Modeling data for those parts can also be retrieved by importing 3D models generated by general-purpose software.

Once modeling job is finished, its data can be exported to different types of standard 3D data format, such ‘.obj’, ‘.3ds’, ‘.igs’ and ‘.wrl’. Relevant drawing can also be generated by projecting the 3D model onto 2D plane.

4-2. Extraction of Fitting Parameters for 3D Face Model

The face model control operative (242) manages fitting parameters in 3D face model.

### 1) Preferred Embodiment

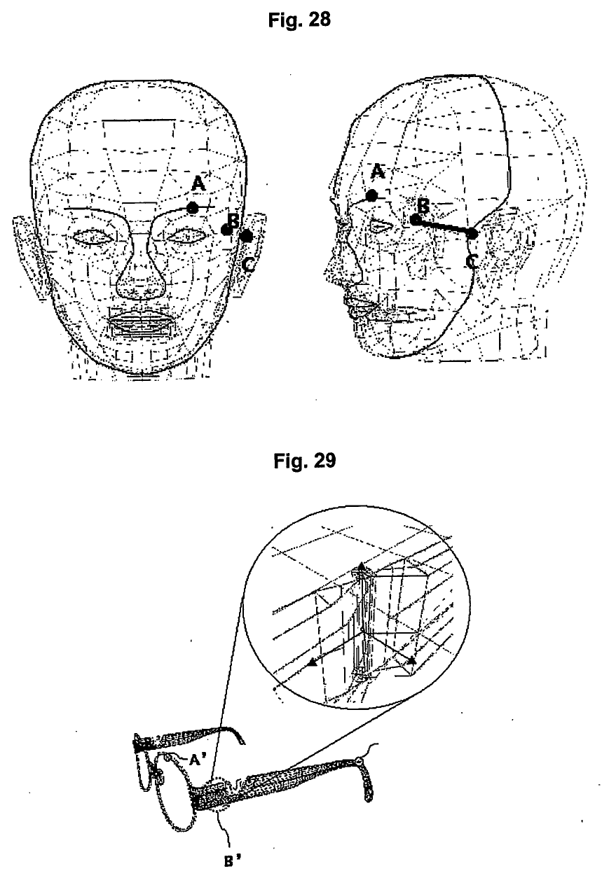

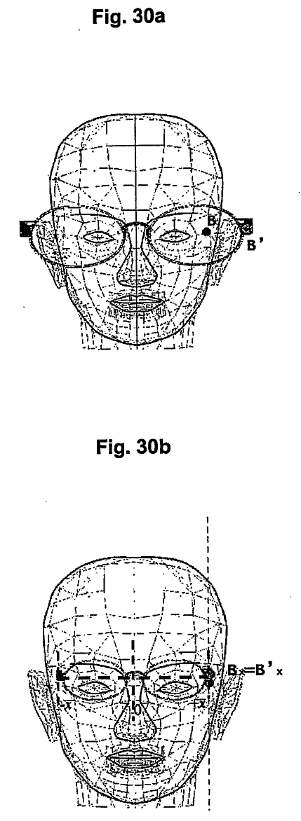

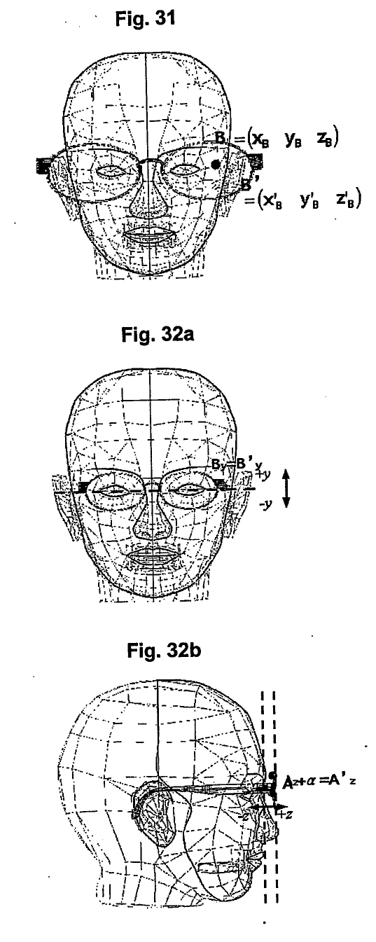

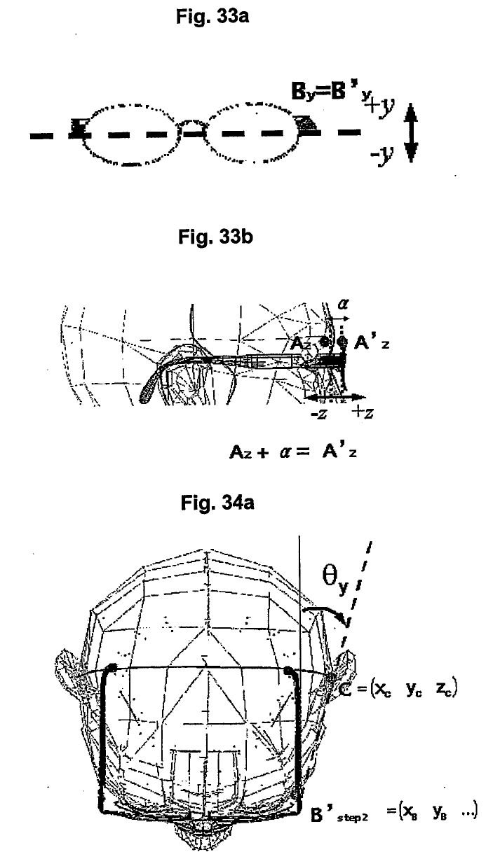

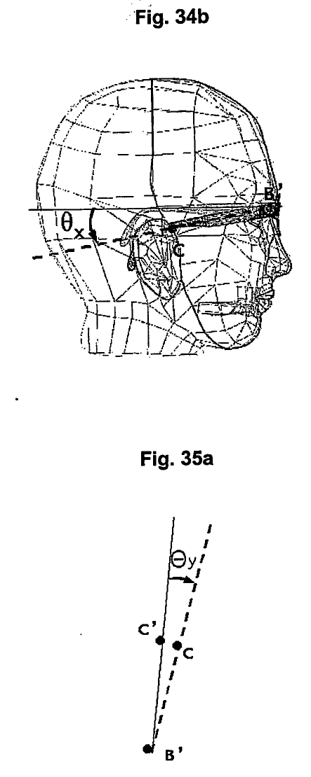

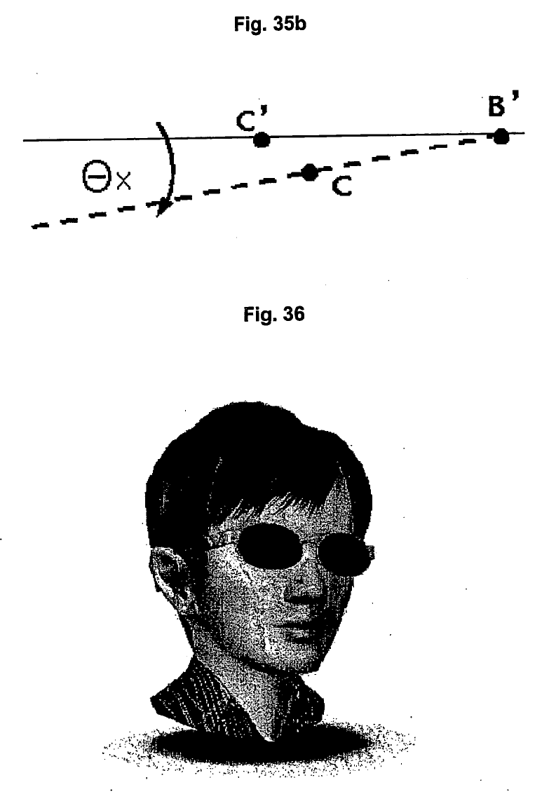

As shown in FIG. 28, fitting parameters of the 3D face model include reference points for the gap distance (A) between the eyes and lenses, and for the hinge (B) in eyeglass and contact point on ears (C). The reference point for gap distance (A) is the vertical top point of eyebrow. The reference point (B) for hinge is on the outer corner of the eyes and outer line of front side face as shown in FIG. 28. The reference point C is contact point on ears is that matches that of a temple.

### 2) Another Preferred Embodiment

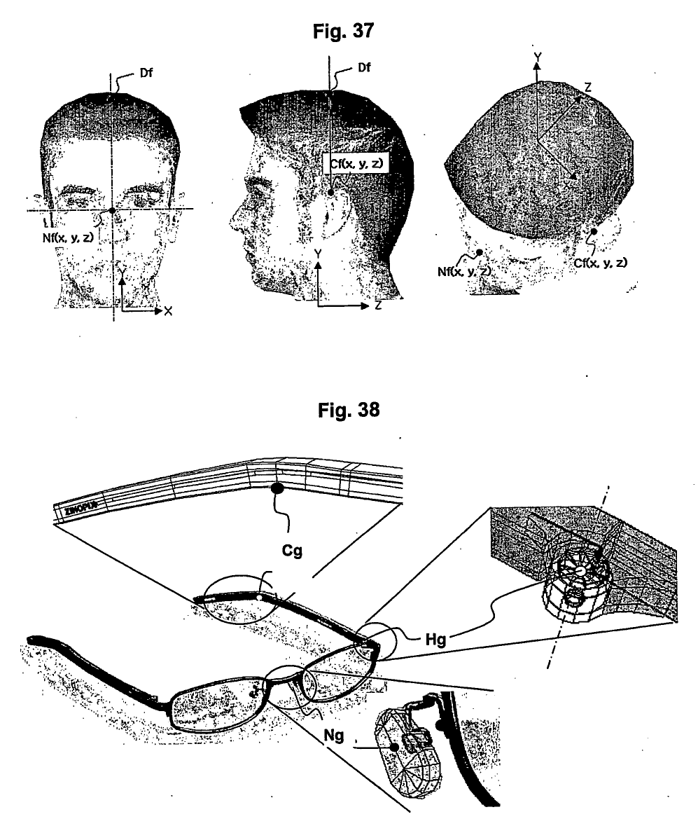

As shown in FIG. 37, the face model control operative (242) implemented another method to fit the 3D eyeglasses model on the 3D face model. This method utilizes following fitting parameters.
a) NF: the center point of the 3D face model
b) CF: the center top of the ear part of the 3D face model that contacts the temple part of the 3D eyeglasses model during virtual-try-on
c) DF: the point at the top of the scalp
   4-3. Extraction of Fitting Parameters for 3D Eyeglasses Model

As in fitting parameters for 3D face model, two different methods are implemented.

### 1) Preferred Embodiment

FIG. 29 shows the fitting parameters of 3D eyeglasses model utilized in the eyeglasses modeling operative (244). Fitting points A′, B′ and C′ are the points that correspond to that of A, B and C in the 3D face model.

### 2) Another Preferred Embodiment

FIG. 38 shows another the fitting parameters for 3D eyeglasses model. The fitting parameters of this method are corresponds to the second fitting parameters of the 3D face model described above. The fitting parameters of eyeglasses are as follows.
a) NG: the center of the nose part of said 3D face model that contacts the nose pad part of the 3D eyeglasses model during virtual-try-on
b) HG: the rotational center of hinge part of the 3D eyeglasses model
c) CG: the center of inner side of the temple part of the 3D eyeglasses model that contact said ear part of the 3D face model
   4-4. Extraction of Fitting Parameters for 3D Hair Model

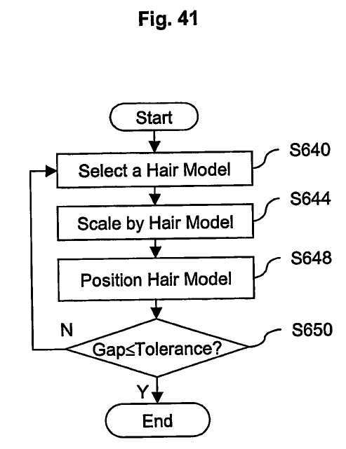

FIG. 41 illustrates the flow of the automatic fitting of 3D hair models. The hair control operative (243) selects a hair model from database (S640) and fits the hair size and position automatically over the 3D face model (S644)(S648). The hair model is moved to proper position by using the difference of the fitting point DF in the face model in FIG. 37 and DH in the hair model in FIG. 39.

4-5. Process to Fit 3D Eyeglasses and 3D Face Model

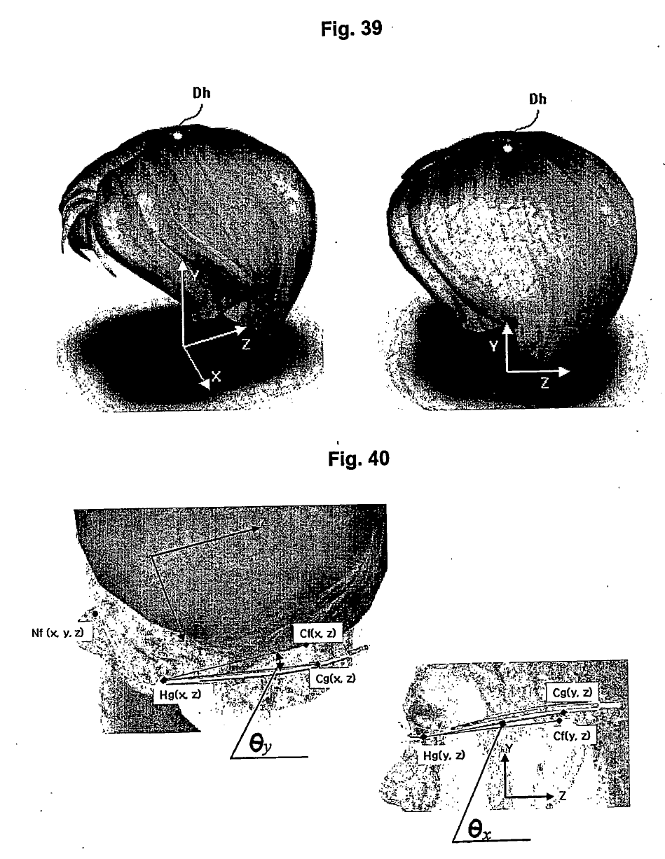

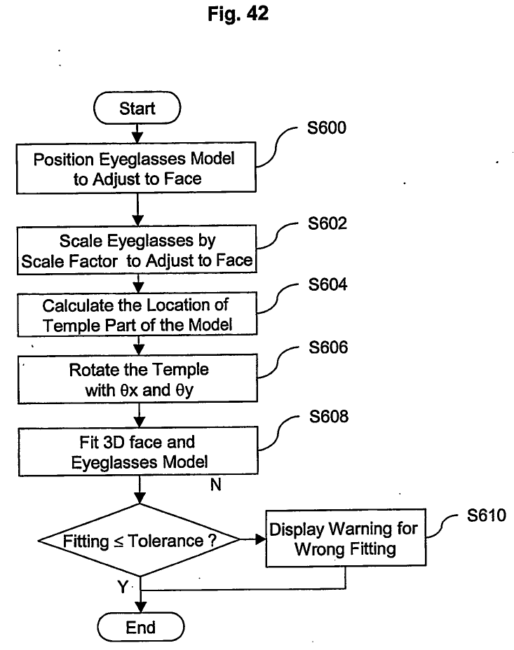

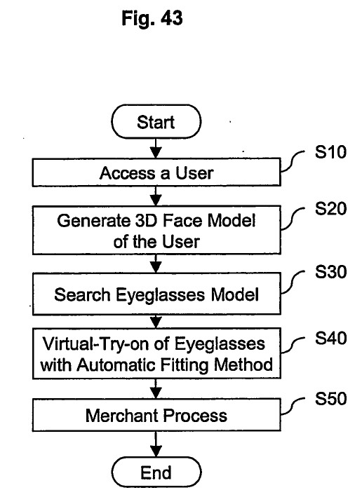

FIG. 37 to FIG. 40 illustrates an automatic fitting process for 3D virtual-try-on of eyeglasses with a 3D face model. The overall process of this operative is illustrated in FIG. 42. This is a fully automatic process performed at-real time and the user does not have to do any further interaction to adjust the 3D eyeglasses model. This method utilizes a pupillary distance of the user and a virtual pupillary distance acquired by user interaction in the 3D face generation operative. If the user does not know his or her pupillary distance value, an average value of pupillary distance is setup depending on demographic characteristics of the user. Detailed fitting process is as follows.
1) As shown in FIG. 37, obtain the coordinates fitting points NF, CF and DF for the 3D face model generated in the face model control operative (242).
2) Fit the 3D hair model to 3D face model using the fitting points Df following the process illustrated in FIG. 41. The operative adjusts the scale of the hair model (S640) and adjust the location (S644)
3) As shown in FIG. 38, obtain the fitting points, NG, HG and CG for the 3D eyeglasses model
4) Calculate for scale, rotation and movement of 3D eyeglasses to adjust using fitting parameters described above following formula.

The scale factor that scales the size of 3D eyeglasses model for automatic fitting is represented by:
SF=X_{B}/X_{B}′,
g=SF·G

Where, SF is the scale factor, X_{B}′ is the X-coordinate of the fitting point B′ for the hinge part of 3D eyeglasses model and X_{B} is the X-coordinate of the corresponding fitting point B for the 3D face model, G is the size of original 3D eyeglasses model and g is a scaled size of the model in X-direction.

The movement in Y-direction to close the gap between the fitting point B for 3D face model and the scaled fitting point b′ by said scale factor for the hinge part of 3D eyeglasses model is represented by:

$$\begin{matrix}Δ Y = {Y}_{B} - {Y}_{{b}^{′}} = {Y}_{B} - {Y}_{B}^{′} \cdot \frac{{X}_{B}}{{X}_{B}^{′}} \\ {b}^{′} = ( {X}_{B}^{′} , {Y}_{B}^{′} \cdot \frac{{X}_{B}}{{X}_{B}^{′}} , {Z}_{B}^{′} \cdot \frac{{X}_{B}}{{X}_{B}^{′}} )\end{matrix}$$

Where, ΔY is the movement of 3D eyeglasses model in Y-direction, (X_{B}′, Y_{B}′, Z_{B}′) are the coordinates of the fitting point B′ for the hinge part of the 3D eyeglasses model, (X_{B}, Y_{B}, Z_{B}) are the coordinates of the corresponding fitting point B for the 3D face model and Y_{b′} is the Y-coordinate of the scaled fitting point b′.

The movement in Z-direction to close the gap between the fitting point A for 3D face model and the scaled fitting point a′ by said scale factor for the hinge part of 3D eyeglasses model is represented by:

$$\begin{matrix}Δ Z = ( {Z}_{A} + α ) - {Z}_{{a}^{′}} = {Z}_{A} + α - {Z}_{A}^{′} \cdot \frac{{X}_{B}}{{X}_{B}^{′}} \\ {a}^{′} = ( {X}_{A}^{′} , {Y}_{A}^{′} \cdot \frac{{X}_{B}}{{X}_{B}^{′}} , {Z}_{A}^{′} \cdot \frac{{X}_{B}}{{X}_{B}^{′}} )\end{matrix}$$

where, ΔZ is the movement of 3D eyeglasses model in Z-direction, (X_{A}′, Y_{A}′, Z_{A}′) are the coordinates of the fitting point A′ for the top center of a lens in the 3D eyeglasses model, (X_{A}, Y_{A}, Z_{A}) are the coordinates of the corresponding fitting point A for top center of an eyebrow in the 3D face model, Z_{a′} is the Z-coordinate of the scaled fitting point a′ and α is the relative distance between the top centers of the lens and the eyebrow.

The rotation angle θ_{y} in X-Z plane with respect to Y-axis represented by the angle calculated from cosine function is represented by:
Cos θ_{y}=Cos(∠CB′C′)_{X-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

The rotation angle θₓ in Y-Z plane with respect to X-axis represented by the angle calculated from cosine function is represented by:
Cos θₓ=Cos(∠CB′C′)_{Y-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

FIG. 36 illustrates the final result of automatic fitting utilizing above method.

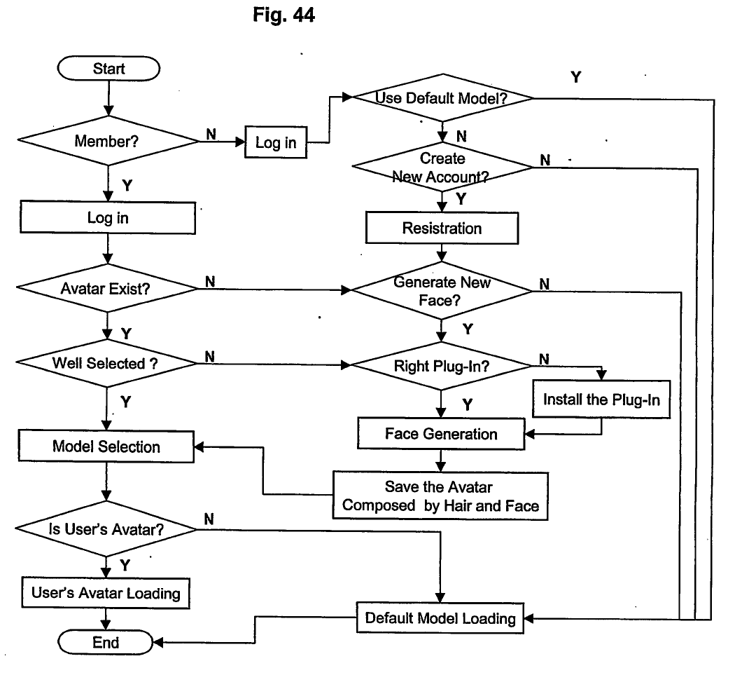

FIG. 44 illustrates the flow of the avatar service flow over the internet platforms.

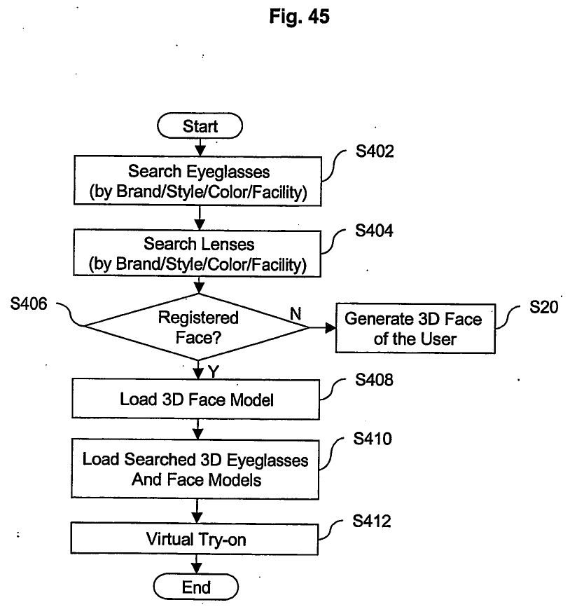

FIG. 45 illustrates the overall flow of the eyeglasses simulation

1. A virtual simulation system connected to a computer network to generate a 3D face model of a user, and to fit the face model and 3D eyeglasses models selected by the user, and to simulate them graphically with a database that stores the information of users, products, 3D models and knowledge base comprising: a user data processing unit to identify the user who needs to have an access to simulation system, and to generate a 3D face model of the user; a graphic simulation unit where a user can visualize 3D eyeglasses model that is generated as the user selects a product in the database, and to place and to fit automatically in 3D space on user's face model created in user data processing module; an intelligent CRM (Customer Relation Management) unit that can advise the user by a knowledge base that provides consulting information acquired by knowledge of fashion expert, purchase history and customer behavior on various products.

2. A system for 3D simulation of eyeglasses according to claim 1, wherein the user data processing unit comprises: A user information management operative to identify authorized user who have a legal access to the system and to maintain user information at each transaction with database; A 3D face model generation operative to create a 3D face model of a user by the information retrieved by the user.

3. A system for 3D simulation of eyeglasses according to claim 2, wherein the 3D face model generation operative comprises a data acquisition operative to generate a 3D face model of a user: by a image capturing device connected to a computer; or by retrieving front or front-and-side view of photo images of the face; or by manipulating 3D face model stored in the database of 3D eyeglasses simulation system.

4. A system for 3D simulation of eyeglasses according to claim 2, wherein the 3D face model generation operative comprises a facial feature extraction operative to generate feature points of a base 3D model as a user input a outline profile and feature points of the face on a device that displays acquired photo images of the face, and to generate a base 3D model.

5. A system for 3D simulation of eyeglasses according to claim 2, wherein the 3D face model generation operative further comprises a 3D face model deformation operative to retrieve precise coordinates points by user interaction, and to deform a base 3D model by relative displacement of reference points from default location by calculated movement of feature points and other points in the vicinity.

6. A system for 3D simulation of eyeglasses according to claim 4, wherein the feature points of a face comprises predefined reference points on outline profile, eyes, nose, mouth and ears of a face.

7. A system for 3D simulation of eyeglasses according to claim 4, wherein the facial feature extraction operative comprises: a face profile extraction operative to extract outline profile of 3D face model from the reference points input by the user; a facial feature points extraction operative to extract feature points that characterize the face of the user from the reference points on of eyes, nose, mouth and ears input by the user

8. A system for 3D simulation of eyeglasses according to claim 4, wherein the 3D face model generation operative further comprises a facial expression operative to deform a 3D face model at-real time to generate human expressions under user's control.

9. A system for 3D simulation of eyeglasses according to claim 4, wherein the 3D face model generation operative further comprises a face composition operative to create a new virtual model by combining a 3D face model of a user generated by the face model deformation operative with that of the others.

10. A system for 3D simulation of eyeglasses according to claim 4, wherein the 3D face model generation operative further comprises a face texture generation operative: to retrieve texture information from photo images provided by a user; to combine textures acquired from front and side view of the photo images; to generate textures for the unseen part of head and face on the photo images.

11. A system for 3D simulation of eyeglasses according to claim 4, wherein the 3D face model generation operative further comprises a real-time preview operative to display 3D face and eyeglasses models with texture over the network, and to display deformation process of the models.

12. A system for 3D simulation of eyeglasses according to claim 4, wherein the 3D face model generation operative further comprises a file managing operative to create and save 3D face model in proprietary format and to convert 3D face model data into industry standard formats.

13. A system for 3D simulation of eyeglasses according to claim 1, wherein the graphic simulation unit comprises: a 3D eyeglasses model management operative to retrieve and store 3D model information on the database by user interaction; a texture generation operative to create colors and texture pattern of 3D eyeglasses models, and to store the data in the database, and to display textures of 3D models on a monitor generated in user data processing unit and eyeglasses modeling operative; a virtual-try-on operative to place 3D eyeglasses and face model in 3D space and to display.

14. A system for 3D simulation of eyeglasses according to claim 13, wherein a 3D eyeglasses model management operative comprise: an eyeglasses modeling operative to create a 3D model and texture of eyeglasses and to generate fitting parameters for virtual-try-on that include reference points for the gap distance between the eyes and lenses, hinges in eyeglasses and contact points on ears; a face model control operative to match fitting parameters generated in eyeglasses modeling operative.

15. A system for 3D simulation of eyeglasses according to claim 13, wherein a 3D virtual-try-on operative comprises: an automatic eyeglasses model fitting operative to deform a 3D eyeglasses model to match a 3D face model automatically at real-time on precise location by using fitting parameters upon user's selection of eyeglasses and face model; an animation operative to display prescribed animation scenarios to illustrate major features of eyeglasses models; a real-time rendering operative to rotate, move, pan, and zoom 3D models by user interaction or by prescribed series of interaction.

16. A system for 3D simulation of eyeglasses according to claim 13, wherein the 3D virtual-try-on operative further comprises a custom-made eyeglasses simulation operative: to build user's own design by combining components of eyeglasses that include lenses, frames, hinges, temples and bridges from built-in library of eyeglasses models and texture; to place imported images of user's name or character to a specific location to build user's own design: to store simulated design in user data processing unit.

17. A system for 3D simulation of eyeglasses according to claim 1 further comprises a commerce transaction unit to operate a merchant process so that a user can purchase the products after trying graphic simulation unit.

18. A system for 3D simulation of eyeglasses according to claim 17, wherein the commerce transaction unit comprises: a purchase management operative to manage orders and purchase history of a user; a delivery management operative to verify order status and to forward shipping information to delivery companies; a inventory management operative to manage the status of inventory along with payment and delivery process.

19. A system for 3D simulation of eyeglasses according to claim 1, wherein the intelligent CRM unit comprises: a product preference analysis operative to analyze the preference on individual product by demographic characteristics of a user and of a category, and to store the analysis result on knowledge base; a customer behavior analysis operative to analyze the characteristics of a user's action on commerce contents, and to store the analysis result on knowledge base; an artificial intelligent learning operative to integrate analysis for product preference and customer behavior with fashion trend information provided by experts in fashion, and construct raw data for advising service dedicated to a customer; a fashion advise generation operative to create advising data from the knowledge base and store it to the database of 3D eyeglasses simulation system, and to deliver dedicated consulting information upon user's demand that include design, style and fashion trend suited for a specific user; an 1:1 marketing data generation operative to acquire and manage demographic information of the user including email address or phone numbers and to publish promotional contents using 3D simulative features; an 1:1 marketing data delivery operative to deliver promotional contents to the multiple telecommunication form factors of the customer.

20. A system for 3D simulation of eyeglasses according to claim 19, the knowledge base comprises a database for log analysis and for advise on fashion trend.

21. A method for 3D simulation of eyeglasses for a 3D eyeglasses simulation system connected to a computer network to generate a 3D face model of a user, and to fit the face model and 3D eyeglasses models selected by the user, and to simulate them graphically with a database that stores the information of users, products, 3D models and knowledge base comprising: a step to generate 3D face model of the user as the user transmit photo images of his or her face to the 3D eyeglasses simulation system, or as the user select one of 3D face model stored in said database; a step to generate 3D eyeglasses model that selects one of 3D models stored in said database and generates 3D model parameters of said eyeglasses model for simulation; a step to simulate virtual-try-on on display monitor that fits said 3D eyeglasses and face model by deforming eyeglasses model at-real time, and that displays combined 3D mages of eyeglasses and face model at different angles.

22. A method for 3D simulation of eyeglasses according to claim 21, the step to generate a 3D face model of the user comprises: a step to display image information from the input provided by the user; a step to extract an outline profile and feature points of said face as the user input base feature points on displayed image information; a step to create a 3D face model by deforming base 3D model with a movement of base feature points observed during user interaction.

23. A method for 3D simulation of eyeglasses according to claim 22, the step to extract an outline profile and feature points of said face comprises: a step to create a base snake as the user input base feature points that include facial features points along outline and featured parts of the face; a step to define vicinity of said snake to move on each points along the snake to vertical direction; a step to move said snake to the direction where color maps of the face in said image information exist.

24. A method for 3D simulation of eyeglasses according to claim 22, the step to extract outline profile and feature points of said face extract similarity between image information of featured parts of the face input by the user and that of predefined generic model.

25. A method for 3D simulation of eyeglasses according to claim 22, the step to create a 3D face model comprises: a step to generate Sibson coordinates of the base feature points; a step to calculate movement of the base feature points to that of said image information; a step to calculate a new coordinates of the base feature points as a summation of coordinates of the default position and the calculated movement.

26. A method for 3D simulation of eyeglasses according to claim 22, the step to create a 3D face model comprises: a step to calculate movement coefficients as a function of movement of the base feature points; a step to calculate new positions of feature points in the vicinity of base points by multiplying movement coefficient.

27. A method for 3D simulation of eyeglasses according to claim 22 further comprises a step to generate facial expressions by deforming said 3D face model generated from said step to create a 3D face model and by using additional information provided by the user.

28. A method for 3D simulation of eyeglasses according to claim 27, the step to generate facial expressions comprises: a step to compute the first light intensity on the entire points over the 3D face model; a step to compute the second light intensity of the image information provided by the user; a step to calculate the ERI (Expression Ratio Intensity) value with the ratio of said second light intensity over that of said second; a step to warp polygons of the face model by using the ERI value to generate human expressions.

29. A method for 3D simulation of eyeglasses according to claim 22 further comprises a step to combine photo image information of the front and side view of the face, and to generate textures of the remaining parts of the head that are unseen by said photo image.

30. A method for 3D simulation of eyeglasses according to claim 29, the generate textures of remaining parts of the head comprises: a step to generate Cartesian coordinates of said 3D face model and to generate texture coordinates of the front and side image of the face; a step to extract a border of said two images and to project the border onto the front and side views to generate textures in the vicinity of the border on the front and side views; a step to blend textures from the front and side views by referencing acquired texture on the border.

31. A method for 3D simulation of eyeglasses according to claim 29, before the step to generate 3D face model of the user, comprises: the first step to check whether the user's 3D face model has been registered before or not; the second step to check whether the user will update registered models or not; the third step to check whether the registered model has been generated by photo image provided by the user or by built-in 3D face model library; the fourth step to load the selected model when it is generated form the information provided by the user.

32. A method for 3D simulation of eyeglasses according to claim 31 further comprises: the fifth step to confirm whether the user will generate a new face model or not when a stored model does not exist; the sixth step to display built-in default models when the user does not want to generate a new model; the seventh to create an avatar from 3D face model generated by photo image of the user by installing dedicated software on personal computer when the software has not been installed before in case the user wants to generate a 3D face model; the eighth step to register the avatar information and to proceed to the third step to check whether the model has been registered or not.

33. A method for 3D simulation of eyeglasses according to claim 31 proceeds to the seventh step and to complete remaining process when the user wants to update the 3D face model in the second step.

34. A method for 3D simulation of eyeglasses according to claim 31 further comprises a step to display the last saved model that has been selected in said third step.

35. A method for 3D simulation of eyeglasses according to claim 31 that checks whether the user has been registered or not as in said first step and identifies that the user is the first visitor comprises: a step to check whether the user select one of built-in default models or not after providing login procedure; a step to display selected default models on the monitor; a step to check to proceed to said seventh step if the user does not select any of built-in default model.

36. A method for 3D simulation of eyeglasses according to claim 21 further comprises a step to select a design of frame and lenses, brand, color, materials or pattern from built-in library for the user.

37. A method for 3D simulation of eyeglasses according to claim 21, the step to generate 3D eyeglasses model that selects one of 3D models stored in the database further comprises a step to provide fashion advise information to the user by intelligent CRM unit can advise the user by a knowledge base that provides consulting information acquired by knowledge of fashion expert, purchase history and customer behavior on various products.

38. A method for 3D simulation of eyeglasses according to claim 21, the step to simulate on display monitor comprises: a step to scale eyeglasses model with respect to X-direction, that is the lateral direction of the 3D face model, by referencing fitting points at eyeglasses and face model that consists of the distance between face and far end part of eyeglasses, hinges in eyeglasses and contact points on ears; a step to transform coordinates of Y-direction, that is up and downward direction to the 3D face model, and Z-direction, that is front and backward direction to the 3D face model, with the scale calculated in X-direction; a step deform temple part of the 3D eyeglasses model to match corresponding fitting points between 3D face and eyeglasses model.

39. A method for 3D simulation of eyeglasses according to claim 38 comprises the scale factor that scales the size of 3D eyeglasses model for automatic fitting represented by:
SF=X_{B}/X_{B}′,
g=SF·G
Where, SF is the scale factor, X_{B}′ is the X-coordinate of the fitting point B′ for the hinge part of 3D eyeglasses model and X_{B} is the X-coordinate of the corresponding fitting point B for the 3D face model, G is the size of original 3D eyeglasses model and g is a scaled size of the model in X-direction.

40. A method for 3D simulation of eyeglasses according to claim 38 comprises the movement in Y-direction to close the gap between the fitting point B for 3D face model and the scaled fitting point b′ by said scale factor for the hinge part of 3D eyeglasses model represented by:
$$\begin{matrix}Δ Y = {Y}_{B} - {Y}_{{b}^{′}} = {Y}_{B} - {Y}_{B}^{′} \cdot \frac{{X}_{B}}{{X}_{B}^{′}} \\ {b}^{′} = ( {X}_{B}^{′} , {Y}_{B}^{′} \cdot \frac{{X}_{B}}{{X}_{B}^{′}} , {Z}_{B}^{′} \cdot \frac{{X}_{B}}{{X}_{B}^{′}} )\end{matrix}$$
where, ΔY is the movement of 3D eyeglasses model in Y-direction, (X_{B}′, Y_{B}′, Z_{B}′) are the coordinates of the fitting point B′ for the hinge part of the 3D eyeglasses model, (X_{B}, Y_{B}, Z_{B}) are the coordinates of the corresponding fitting point B for the 3D face model and Y_{b′} is the Y-coordinate of the scaled fitting point b′

41. A method for 3D simulation of eyeglasses according to claim 38 comprises the movement in Z-direction to close the gap between the fitting point A for 3D face model and the scaled fitting point a′ by said scale factor for the hinge part of 3D eyeglasses model represented by:
$$\begin{matrix}Δ Z = ( {Z}_{A} + α ) - {Z}_{{a}^{′}} = {Z}_{A} + α - {Z}_{A}^{′} \cdot \frac{{X}_{B}}{{X}_{B}^{′}} \\ {a}^{′} = ( {X}_{A}^{′} , {Y}_{A}^{′} \cdot \frac{{X}_{B}}{{X}_{B}^{′}} , {Z}_{A}^{′} \cdot \frac{{X}_{B}}{{X}_{B}^{′}} )\end{matrix}$$
where, ΔZ is the movement of 3D eyeglasses model in Z-direction, (X_{A}′, Y_{A}′, Z_{A}′) are the coordinates of the fitting point A′ for the top center of a lens in the 3D eyeglasses model, (X_{A}, Y_{A}, Z_{A}) are the coordinates of the corresponding fitting point A for top center of an eyebrow in the 3D face model, Z_{a′} is the Z-coordinate of the scaled fitting point a′ and α is the relative distance between the top centers of the lens and the eyebrow.

42. A method for 3D simulation of eyeglasses according to claim 38 comprises the rotation angle θ_{y} in X-Z plane with respect to Y-axis represented by the angle calculated from cosine function represented by:
Cos θ_{y}=Cos(∠CB′C′)_{X-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

43. A method for 3D simulation of eyeglasses according to claim 38 comprises the rotation angle θₓ in Y-Z plane with respect to X-axis represented by the angle calculated from cosine function represented by:
Cos θₓ=Cos(∠CB′C′)_{Y-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

44. A storage media to read a program to from a computer network to generate a 3D face model of a user, and to fit the face model and 3D eyeglasses models selected by the user, and to simulate them graphically with a database that stores the information of users, products, 3D models and knowledge base, to execute a program comprising: an operative to generate 3D face model of the user as the user transmit photo images of his or her face to the 3D eyeglasses simulation system, or as the user select one of 3D face model stored in said database; an operative to generate 3D eyeglasses model that selects one of 3D models stored in said database and generates 3D model parameters of said eyeglasses model for simulation; an operative to simulate virtual-try-on on display monitor that fits said 3D eyeglasses and face model by transforming the Y and Z-coordinates of 3D eyeglasses model with the scale factor calculated from X-direction, using the gap distance between the eyes and the lenses and the fitting points for the ear part of the face model and for the hinge and the temple part of the eyeglasses model, and that displays combined 3D images of eyeglasses and face model at different angles.

45. A method to generate a 3D face model comprising: (a) a step to input a 2D photo image of a face in front view and to display said image; (b) a step to input at least one base points, on the said image, that characterizes a human face; (c) a step to extract an outline profile and feature points for eyes, nose, mouth and ears that construct feature shapes of said face; (d) a step to convert said input image information to a 3D face model using said outline profile and feature points.

46. A method to generate a 3D face model according to claim 45, the base points include at least one points in the outline profile of the face, and the step (c) to extract the outline profile of the face comprises: (c1) a step to generate a base snake on said face information on said image referencing said base points; (c2) a step to extract the outline profile by moving snake of the said face to the direction where textures of the face exist.

47. A method to generate a 3D face model according to claim 45, the base points include at least one points that correspond to eyes, nose, mouth and ears, and the step (c) to extract the outline profile of the face comprises: a step to comprise a standard image information for a standard 3D face model; (c2) a step to extract feature points of said input image by analyzing the similarity in image information of the featured shape and that of the standard image.

48. A method to generate a 3D face model according to claim 45, the step (a) to input said 2D image provides a facility to zoom in, zoom out or rotate said image upon user's demand, and the step (b) comprises: (b1) a step to input the size and degree of rotation of the said image by the user; (b2) a step to generate a vertical center line for the face and to input base points for outline profile of the face, the step (c) comprises: (c1) a step to generate base snake of the face by the said base points of the said image of the face; (c2) a step to extract outline profile of the face by moving said snake to the direction where texture of the face exist; (c3) a step to comprise standard image information for 3D face model; (c4) a step to extract feature points of said input image by analyzing the similarity in image information of the featured shape and that of the standard image; (c5) a step to display the outline profile or the feature points along the outline profile to the user, and to provide a facility to modify said profile or feature points, and to finalize the outline profile and feature points of said face.

49. A method to generate a 3D face model according to claim 45 further comprises: (e) a step to generate 3D face model by deforming said face image information using the movement of base feature points in the standard image information to extracted feature points by user interaction on said face image.

50. A method to generate a 3D face model according to claim 49, the step (e) comprises: (e1) a step to generate Sibson coordinates on the original position of the base points extracted from the step to deform said face model; (e2) a step to calculate movements of each base points to the corresponding position of said image information; (e3) a step to calculate a new position with a summation of coordinates of the original positions and said movements; (e4) a step to generate 3D face model that corresponds to adjusted image information, by new positions, of said face.

51. A method to generate a 3D face model according to claim 49, the step (e) comprises: (e1) a step to calculate the movement of base points; (e2) a step to calculate new positions of base points and their vicinity that have by using said movement; (e3) a step to generate 3D face model that corresponds to adjusted image information, by new positions, of said face.

52. A method to generate a 3D face model according to claim 45 further comprises: (f) a step to generate facial expressions by deforming said 3D face model generated from said step to create a 3D face model and by using additional information provided by the user.

53. A method to generate a 3D face model according to claim 52, the step (f) comprises: (f1) a step to compute the first light intensity on the entire points over the 3D face model; (f2) a step to compute the second light intensity of the image information provided by the user; (f3) a step to calculate the ERI (Expression Ratio Intensity) value with the ratio of said second light intensity over that of said second; (f4) a step to warp polygons of the face model by using the ERI value to generate human expressions.

54. A method to generate a 3D face model according to claim 45 further comprises: (g) a step to combine photo image information of the front and side view of the face, and to generate textures of the remaining parts of the head that are unseen by said photo image.

55. A method to generate a 3D face model according to claim 54, the step (g) comprises: (g1) a step to generate Cartesian coordinates of said 3D face model and to generate texture coordinates of the front and side image of the face; (g2) a step to extract a border of said two images and to project the border onto the front and side views to generate textures in the vicinity of the border on the front and side views; (g3) a step to blend textures from the front and side views by referencing acquired texture on the border.

56. A method to generate a 3D face model according to claim 45 further comprises: (h) a step to provide a facility for the user to select a hair models from a built-in library of 3D hair models, and to fit said hair model onto said 3D face model.

57. A method to generate a 3D face model according to claim 54, the step (h) comprises: (h1) a step to comprise a library of 3D hair models in at least one category in hair style; (h2) a step for the user to select a hair model from the built-in library of 3D hair models; (h3) a step to extract a fitting point for the 3D hair model that matches the top position of the scalp on the vertical center line of said 3D face model; (h4) a step to calculate the scale that matches to said 3D face model, and to fit 3D hair and face model together by using said fitting point for the hair.

58. A method for 3D simulation of eyeglasses comprising: (a) a step to acquire photographic image information from front, side and top views of eyeglasses placed in a cubic box with a measure in transparent material; (b) a step to generate a base 3D model for eyeglasses by using measured value from said images or by combining components from a built-in library for 3D eyeglasses component models and textures; (c) a step to generate a 3D lens model parametrically with the geometric information about lens shape, curvature, slope and focus angle; (d) a step to generate a shape of the bridge and frame of eyeglasses by using measured value from said image and to combine said lenses, bridge and frame model together to generate a 3D complete model for eyeglasses.

59. A method for 3D simulation of eyeglasses according to claim 58, the step (c) comprises: (c1) a step to acquire curvature information from said images or by specification of the product, and to create a sphere model that matches said curvature or predefined curvature preference; (c2) a step to project the outline profile the lens to the surface of the sphere model and to trim out inner part of the projected surface.

60. A method for 3D simulation of eyeglasses according to claim 59 further comprises: (c3) a step to generate thickness on trimmed surface of the lens.

61. A method for 3D simulation of eyeglasses according to claim 58, the step (d) comprises: (d1) a step to display the base 3D model to the user, and to acquire input parameters for adjusting the 3D frame model, and to deform said frame model with acquired parameters; (d2) a step to mirror said 3D lens model with respect to center line defined by user input or measured by said photo images and generate a pair of lenses in symmetry, and to generate a 3D bridge model with the parameters defined by user input or measured by said photo images.

62. A method for 3D simulation of eyeglasses according to claim 61, the step (d) further comprises: (d3) a step to generate a connection part of the 3D frame model between temple and lens frame with the parameters defined by user input or measured by said photo images, or by the built-in 3D component library.

63. A method for 3D simulation of eyeglasses according to claim 58 further comprises: (e) a step to generate temple part of the 3D frame model with the parameters defined by user input or measured by said photo images, or by the built-in 3D component library, while matching topology of said connection part and to convert automatically in a format of polygons; (f) a step to deform temple part of the 3D frame model to match the curvature measured by said photo images or predefined curvature preference; (g) a step to mirror said 3D temple model with respect to center line defined by user input or measured by said photo images and generate a pair of lenses in symmetry.

64. A method for 3D simulation of eyeglasses according to claim 58 further comprises: (h) a step to generate a nose part, a hinge part, screws, bolts and nuts from with the parameters defined by user input or built-in 3D component library.

65. A method for 3D simulation of eyeglasses comprising:
(a) a step to comprise at least one 3D eyeglasses and 3D face model information; (b) a step to select a 3D face model and 3D eyeglasses model by a user from said model information; (c) a step to fit automatically said face and eyeglasses model at-real time; (d) a step to compose a 3D image of said face and eyeglasses model, and to display generated said 3D image upon the user's demand.

66. A method for 3D simulation of eyeglasses according to claim 65, the step (c) comprises: (c1) a step to adjust to the scale of the 3D eyeglasses model in X-direction, that is the lateral direction of the 3D face model, with the fitting points for hinge part of the 3D eyeglasses model, for corresponding fitting points in 3D face model, for top center of the ear part of the 3D face model, for gap distance between eyes and lenses; (c2) a step to transform the coordinates and the location of 3D eyeglasses model in Y-direction, that is up and downward direction to the 3D face model, and Z-direction, that is front and backward direction to the 3D face model, with the scale calculated in X-direction; (c3) a step to deform temple part of the 3D eyeglasses model to match corresponding fitting points between 3D face and eyeglasses model.

67. A method for 3D simulation of eyeglasses according to claim 66, the step (c1) comprises the scale factor that scales the size of 3D eyeglasses model for automatic fitting represented by:
SF=X_{B}/X_{B}′,
g=SF·G
Where, SF is the scale factor, X_{B}′ is the X-coordinate of the fitting point B′ for the hinge part of 3D eyeglasses model and X_{B} is the X-coordinate of the corresponding fitting point B for the 3D face model, G is the size of original 3D eyeglasses model and g is a scaled size of the model in X-direction.

68. A method for 3D simulation of eyeglasses according to claim 67 comprises the movement in Y-direction to close the gap between the fitting point B for 3D face model and the scaled fitting point b′ by said scale factor for the hinge part of 3D eyeglasses model represented by:
$$\begin{matrix}Δ Y = {Y}_{B} - {Y}_{{b}^{′}} = {Y}_{B} - {Y}_{B}^{′} \cdot \frac{{X}_{B}}{{X}_{B}^{′}} \\ {b}^{′} = ( {X}_{B}^{′} , {Y}_{B}^{′} \cdot \frac{{X}_{B}}{{X}_{B}^{′}} , {Z}_{B}^{′} \cdot \frac{{X}_{B}}{{X}_{B}^{′}} )\end{matrix}$$
Where, ΔY is the movement of 3D eyeglasses model in Y-direction, (X_{B}′, Y_{B}′, Z_{B}′) are the coordinates of the fitting point B′ for the hinge part of the 3D eyeglasses model, (X_{B}, Y_{B}, Z_{B}) are the coordinates of the corresponding fitting point B for the 3D face model and Y_{b′} is the Y-coordinate of the scaled fitting point b′

69. A method for 3D simulation of eyeglasses according to claim 65 comprises the movement in Z-direction to close the gap between the fitting point A for 3D face model and the scaled fitting point a′ by said scale factor for the hinge part of 3D eyeglasses model represented by:
$$Δ Z = ( {Z}_{A} + α ) - {Z}_{{a}^{′}} = {Z}_{A} + α - {Z}_{A}^{′} \cdot \frac{{X}_{B}}{{X}_{B}^{′}} \\ {a}^{′} = ( {X}_{A}^{′} , {Y}_{A}^{′} \cdot \frac{{X}_{B}}{{X}_{B}^{′}} , {Z}_{A}^{′} \cdot \frac{{X}_{B}}{{X}_{B}^{′}} )$$
where, ΔZ is the movement of 3D eyeglasses model in Z-direction, (X_{A}′, Y_{A}′, Z_{A}′) are the coordinates of the fitting point A′ for the top center of a lens in the 3D eyeglasses model, (X_{A}, Y_{A}, Z_{A}) are the coordinates of the corresponding fitting point A for top center of an eyebrow in the 3D face model, Z_{a′} is the Z-coordinate of the scaled fitting point a′ and α is the relative distance between the top centers of the lens and the eyebrow.

70. A method for 3D simulation of eyeglasses according to claim 65 comprises the rotation angle θ_{y} in X-Z plane with respect to Y-axis represented by the angle calculated from cosine function represented by:
Cos θ_{y}=Cos(∠CB′C′)_{X-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

71. A method for 3D simulation of eyeglasses according to claim 65 comprises the rotation angle θₓ in Y-Z plane with respect to X-axis represented by the angle calculated from cosine function represented by:
Cos θₓ=Cos(∠CB′C′)_{Y-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

72. A method for 3D simulation of eyeglasses according to claim 65, the step (c) comprises: (c1) a step to input center points of the fitting region, NF, CF, DF, NG, HG and CG, in that 3D eyeglasses model and 3D face model contact each other, where NF is the center point of said 3D face model, CF is the center top of the ear part of said 3D face model that contacts the temple part of the 3D eyeglasses model during virtual-try-on, DF is the point at the top of the scalp, NG is the center of the nose part of said 3D face model that contacts the nose pad part of the 3D eyeglasses model during virtual-try-on, HG is the rotational center of hinge part of the 3D eyeglasses model and CG is the center of inner side of the temple part of the 3D eyeglasses model that contact said ear part of the 3D face model; (c2) a step to obtain new coordinates set for said 3D eyeglasses model using said value of NF, CF, DF, NG, HG and CG that are need to fit eyeglasses on face model; (c3) a step to fit said 3D eyeglasses model on said 3D face model automatically at-real time.

73. A method for 3D simulation of eyeglasses according to claim 72, the step (c2) comprises; (c2i) a step to move said 3D eyeglasses model to proper position by using the difference of said NF and said NG; (c2ii) a step for the user to input his or her own PD, pupillary distance, and to calculate PD value of said 3D face and corresponding value of 3D eyeglasses model; (c2iii) a step to calculate the rotation angles for the template part of said eyeglasses model in horizontal plane to be fitted on said 3D face model by using said CF and HG value; (c2iv) a step to deform 3D eyeglasses model and to fit on said 3D face model by using said values and angles.

74. A method for 3D simulation of eyeglasses according to claim 73, the step (c2ii) comprises a step to define a value between 63 and 72 millimeters without having input from the user.

75. An eyeglasses marketing method comprising: (a) a step to generate 3D face model of a user a with a photo image of the face, and to generate image information to combine said 3D face model and stored 3D eyeglasses model, and to deliver said image information to a customer; (b) a step to retrieve at least one selection of the 3D eyeglasses model by the user, and to manage purchase inquiry information of the eyeglasses, that corresponds to 3D eyeglasses model, inputted by the user; (c) a step to analyze the environment where said purchase inquiry occurs including analysis or occasion of customer behavior on the corresponding inquiry and eyeglass product; (d) a step to analyze the customer's preference on eyeglasses product inquired and to manage the preference result; (e) a step to forecast trend future trend of fashion driven from said analysis step for product preference and analysis result for customer behavior and acquired information on eyeglasses fashion; (f) a step to acquire future trend of fashion by an artificial intelligent learning tool dedicated to fashion trend forecast, and to generate a knowledge base that advise suited design or proper fashion trend upon customer's request; (g) a step to generate a promotional contents for eyeglasses for a specific customer based on the integrated information about customer preference obtained from said customer behavior analysis tool, advising information generated by said knowledge base and artificial intelligent learning tool; (h) a step to acquire and manage demographic information of the user including email address or phone numbers and to publish promotional contents using 3D simulative features, and to deliver promotional contents to the multiple telecommunication form factors of the customer.

76. An eyeglasses marketing method according to claim 75, the step (g) comprises: a step to categorize customers by a predefined rule and to generate promotional contents according to said category.

77. An eyeglasses marketing method according to claim 75, the step (d) and (e) comprises analysis for the customer that includes at least one parameter for hair texture of 3D face model of the customer, lighting of the face, skin tone, width of the face, length of the face, size of the mouth, interpupillary distance and race of the customer.

78. An eyeglasses marketing method according to claim 75, the step (d) comprises the analysis for the eyeglasses product that includes at least one parameter for size of the frame and lenses, shape of the frame and lenses, material of the frame and lenses, color of the frame, color of the lenses, model year, brand and price.

79. An eyeglasses marketing method according to claim 75, the step (d) comprises analysis for the product preference that includes at least one parameter for seasonal trend in fashion, seasonal trend of eyeglasses shape, width of the face, race, skin tone, interpupillary distance, and hair style in the 3D face model.

80. A device to generate a 3D face model comprising: an operative to input a 2D photo image of a face in front view and to display said image and to input at least one base points, on the said image, that characterizes a human face; an operative to extract an outline profile and feature points for eyes, nose, mouth and ears that construct feature shapes of said face; an operative to convert said input image information to a 3D face model using said outline profile and feature points.

81. A device to generate a 3D face model according to claim 80, the base points include at least one points in the outline profile of the face, and said operative to extract the outline profile of the face comprises: an operative to generate a base snake on said face information on said image referencing said base points; an operative to extract the outline profile by moving snake of the said face to the direction where textures of the face exist.

82. A device to generate a 3D face model according to claim 80, the base points include at least one points that correspond to eyes, nose, mouth and ears, and the operative to extract the outline profile of the face comprises: a database to comprise a standard image information for a standard 3D face model; an operative to extract feature points of said input image by analyzing the similarity in image information of the featured shape and that of the standard image.

83. A device to generate a 3D face model according to claim 80, the operative to input said 2D image provides a facility to zoom in, zoom out or rotate said image upon user's demand, retrieves the size and degree of rotation of the said image by the user, and generates a vertical center line for the face and to input base points for outline profile of the face, the operative to extract the outline profile of the face comprises: an operative to generate base snake of the face by the said base points of the said image of the face and to extract outline profile of the face by moving said snake to the direction where texture of the face exist; an operative to comprise a database of standard image information for 3D face model; an operative to extract feature points of said input image by analyzing the similarity in image information of the featured shape and that of the standard image; an operative to display the outline profile or the feature points along the outline profile to the user, and to provide a facility to modify said profile or feature points, and to finalize the outline profile and feature points of said face.

84. A device to generate a 3D face model according to claim 80 further comprises: an operative to generate 3D face model by deforming said face image information using the movement of base feature points in the standard image information to extracted feature points by user interaction on said face image.

85. A device to generate a 3D face model according to claim 84, the operative to deform 3D face model comprises: an operative to generate Sibson coordinates on the original position of the base points extracted from the operative to deform said face model; an operative to calculate movements of each base points to the corresponding position of said image information; an operative to calculate a new position with a summation of coordinates of the original positions and said movements; (e4) an operative to generate 3D face model that corresponds to adjusted image information, by new positions, of said face.

86. A device to generate a 3D face model according to claim 84, the operative to deform 3D face model: an operative to calculate the movement of base points; an operative to calculate new positions of base points and their vicinity that have by using said movement; an operative to generate 3D face model that corresponds to adjusted image information, by new positions, of said face.

87. A device to generate a 3D face model according to claim 80 further comprises an operative to generate facial expressions by deforming said 3D face model generated from said operative to create a 3D face model and by using additional information provided by the user.

88. A device to generate a 3D face model according to claim 87, the operative to generate facial expressions comprises: an operative to compute the first light intensity on the entire points over the 3D face model; an operative to compute the second light intensity of the image information provided by the user; (f3) an operative to calculate the ERI (Expression Ratio Intensity) value with the ratio of said second light intensity over that of said second; (f4) an operative to warp polygons of the face model by using the ERI value to generate human expressions.

89. A device to generate a 3D face model according to claim 80 further comprises: an operative to combine photo image information of the front and side view of the face, and to generate textures of the remaining parts of the head that are unseen by said photo image.

90. A device to generate a 3D face model according to claim 89, the operative comprises: an operative to generate Cartesian coordinates of said 3D face model and to generate texture coordinates of the front and side image of the face; an operative to extract a border of said two images and to project the border onto the front and side views to generate textures in the vicinity of the border on the front and side views; an operative to blend textures from the front and side views by referencing acquired texture on the border.

91. A device to generate a 3D face model according to claim 80 further comprises: an operative to provide a facility for the user to select a hair models from a built-in library of 3D hair models, and to fit said hair model onto said 3D face model.

92. A device to generate a 3D face model according to claim 91, the operative comprises: an operative to comprise a library of 3D hair models in at least one category in hair style; an operative for the user to select a hair model from the built-in library of 3D hair models; an operative to extract a fitting point for the 3D hair model that matches the top position of the scalp on the vertical center line of said 3D face model; an operative to calculate the scale that matches to said 3D face model, and to fit 3D hair and face model together by using said fitting point for the hair.

93. A device to generate a 3D eyeglasses model comprising: an operative to acquire photographic image information from front, side and top views of eyeglasses placed in a cubic box with a measure in transparent material; an operative to generate a base 3D model for eyeglasses by using measured value from said images; an operative to generate a 3D lens model parametrically with the geometric information about lens shape, curvature, slope and focus angle; an operative to generate a shape of the bridge and frame of eyeglasses by using measured value from said image and to combine said lenses, bridge and frame model together to generate a 3D complete model for eyeglasses.

94. A device to generate a 3D eyeglasses model according to claim 93, the operative to generate a 3D lens model comprises: an operative to acquire curvature information from said images and to create a sphere model that matches said curvature or predefined curvature preference; an operative to project the outline profile the lens to the surface of the sphere model and to trim out inner part of the projected surface.

95. A device to generate a 3D eyeglasses model according to claim 94 further comprises: an operative to generate thickness on trimmed surface of the lens.

96. A device to generate a 3D eyeglasses model according to claim 93, the operative to generate a 3D model comprises: an operative to display the base 3D model to the user, and to acquire input parameters for adjusting the 3D frame model, and to deform said frame model with acquired parameters; an operative to mirror said 3D lens model with respect to center line defined by user input or measured by said photo images and generate a pair of lenses in symmetry, and to generate a 3D bridge model with the parameters defined by user input or measured by said photo images.

97. A device to generate a 3D eyeglasses model according to claim 96, the operative to generate a 3D model comprises further comprises: an operative to generate a connection part of the 3D frame model between temple and lens frame with the parameters defined by user input or measured by said photo images, or by built-in 3D component library.

98. A device to generate a 3D eyeglasses model according to claim 93 further comprises: an operative to generate temple part of the 3D frame model while matching topology of said connection part and to convert automatically in a format of polygons; an operative a step to deform temple part of the 3D frame model to match the curvature measured by said photo images or predefined curvature preference; an operative a step to mirror said 3D temple model with respect to center line defined by user input or measured by said photo images and generate a pair of lenses in symmetry.

99. A device to generate a 3D eyeglasses model according to claim 93 further comprises: an operative to generate a nose part, a hinge part, screws, bolts and nuts from with the parameters defined by user input or built-in 3D component library.

100. A device for 3D simulation of eyeglasses comprising: a database that comprises at least one 3D eyeglasses and 3D face model information; an operative to select a 3D face model and 3D eyeglasses model by a user from said model information; an operative to fit automatically said face and eyeglasses model at-real time; an operative to compose a 3D image of said face and eyeglasses model, and to display generated said 3D image upon the user's demand.

101. A device for 3D simulation of eyeglasses according to claim 100, the operative to fit eyeglasses model comprises: an operative to adjust to the scale of the 3D eyeglasses model in X-direction, that is the lateral direction of the 3D face model, with the fitting points for hinge part of the 3D eyeglasses model, for corresponding fitting points in 3D face model, for top center of the ear part of the 3D face model, for gap distance between eyes and lenses; an operative to transform the coordinates and the location of 3D eyeglasses model in Y-direction, that is up and downward direction to the 3D face model, and Z-direction, that is front and backward direction to the 3D face model, with the scale calculated in X-direction; an operative to deform temple part of the 3D eyeglasses model to match corresponding fitting points between 3D face and eyeglasses model.

102. A device for 3D simulation of eyeglasses according to claim 101, the operative to adjust the scale comprises the scale factor that scales the size of 3D eyeglasses model for automatic fitting represented by:
SF=X_{B}/X_{B}′,
g=SF·G
Where, SF is the scale factor, X_{B}′ is the X-coordinate of the fitting point B′ for the hinge part of 3D eyeglasses model and X_{B} is the X-coordinate of the corresponding fitting point B for the 3D face model, G is the size of original 3D eyeglasses model and g is a scaled size of the model in X-direction.

103. A device for 3D simulation of eyeglasses according to claim 102 comprises the movement in Y-direction to close the gap between the fitting point B for 3D face model and the scaled fitting point b′ by said scale factor for the hinge part of 3D eyeglasses model represented by:
$$Δ Y = {Y}_{B} - {Y}_{{b}^{′}} = {Y}_{B} - {Y}_{B}^{′} \cdot \frac{{X}_{B}}{{X}_{B}^{′}}$$
$${b}^{′} = ( {X}_{B}^{′} , {Y}_{B}^{′} \cdot \frac{{X}_{B}}{{X}_{B}^{′}} , {Z}_{B}^{′} \cdot \frac{{X}_{B}}{{X}_{B}^{′}} )$$
Where, ΔY is the movement of 3D eyeglasses model in Y-direction, (X_{B}′, Y_{B}′, Z_{B}′) are the coordinates of the fitting point B′ for the hinge part of the 3D eyeglasses model, (X_{B}, Y_{B}, Z_{B}) are the coordinates of the corresponding fitting point B for the 3D face model and Y_{b′} is the Y-coordinate of the scaled fitting point b′

104. A device for 3D simulation of eyeglasses according to claim 101 comprises the movement in Z-direction to close the gap between the fitting point A for 3D face model and the scaled fitting point a′ by said scale factor for the hinge part of 3D eyeglasses model represented by:
$$Δ Z = ( {Z}_{A} + α ) - {Z}_{{a}^{′}} = {Z}_{A} + α - {Z}_{A}^{′} \cdot \frac{{X}_{B}}{{X}_{B}^{′}} \\ {a}^{′} = ( {X}_{A}^{′} , {Y}_{A}^{′} \cdot \frac{{X}_{B}}{{X}_{B}^{′}} , {Z}_{A}^{′} \cdot \frac{{X}_{B}}{{X}_{B}^{′}} )$$
where, ΔZ is the movement of 3D eyeglasses model in Z-direction, (X_{A}′, Y_{A}′, Z_{A}′) are the coordinates of the fitting point A′ for the top center of a lens in the 3D eyeglasses model, (X_{A}, Y_{A}, Z_{A}) are the coordinates of the corresponding fitting point A for top center of an eyebrow in the 3D face model, Z_{a′} is the Z-coordinate of the scaled fitting point a′ and α is the relative distance between the top centers of the lens and the eyebrow.

105. A device for 3D simulation of eyeglasses according to claim 101 comprises the rotation angle θ_{y} in X-Z plane with respect to Y-axis represented by the angle calculated from cosine function represented by:
Cos θ_{y}=Cos(∠CB′C′)_{X-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

106. A device for 3D simulation of eyeglasses according to claim 101 comprises the rotation angle θₓ in Y-Z plane with respect to X-axis represented by the angle calculated from cosine function represented by:
Cos θₓ=Cos(∠CB′C′)_{Y-Z}
where, C is the fitting point for the vertical top point in the ear of the 3D face model that contacts with temple part of the 3D eyeglasses model, C′ is the corresponding fitting point for the temple part of the 3D eyeglasses model and B′ is the fitting point for the hinge part of the 3D eyeglasses.

107. A device for 3D simulation of eyeglasses according to claim 100, the operative to fit 3D eyeglasses comprises: an operative to input center points of the fitting region, NF, CF, DF, NG, HG and CG, in that 3D eyeglasses model and 3D face model contact each other, where NF is the center point of said 3D face model, CF is the center top of the ear part of said 3D face model that contacts the temple part of the 3D eyeglasses model during virtual-try-on, DF is the point at the top of the scalp, NG is the center of the nose part of said 3D face model that contacts the nose pad part of the 3D eyeglasses model during virtual-try-on, HG is the rotational center of hinge part of the 3D eyeglasses model and CG is the center of inner side of the temple part of the 3D eyeglasses model that contact said ear part of the 3D face model; an operative to obtain new coordinates set for said 3D eyeglasses model using said value of NF, CF, DF, NG, HG and CG that are need to fit eyeglasses on face model; an operative to fit said 3D eyeglasses model on said 3D face model automatically at-real time.

108. A device for 3D simulation of eyeglasses according to claim 107, the operative to obtain new coordinates comprises; an operative to move said 3D eyeglasses model to proper position by using the difference of said NF and said NG; an operative a step for the user to input his or her own PD, pupillary distance, and to calculate PD value of said 3D face and corresponding value of 3D eyeglasses model; an operative a step to calculate the rotation angles for the template part of said eyeglasses model in horizontal plane to be fitted on said 3D face model by using said CF and HG value; an operative a step to deform 3D eyeglasses model and to fit on said 3D face model by using said values and angles.

109. A device for 3D simulation of eyeglasses according to claim 73, the step (c2ii) comprises a step to define a value between 63 and 72 millimeters without having input from the user.

110. A device for marketing of eyeglasses comprising: an operative to generate 3D face model of a user a with a photo image of the face, and to generate image information to combine said 3D face model and stored 3D eyeglasses model, and to deliver said image information to a customer; an operative to retrieve at least one selection of the 3D eyeglasses model by the user, and to manage purchase inquiry information of the eyeglasses, that corresponds to 3D eyeglasses model, inputted by the user; an operative to analyze the environment where said purchase inquiry occurs including analysis or occasion of customer behavior on the corresponding inquiry and eyeglass product; an operative to analyze the customer's preference on eyeglasses product inquired and to manage the preference result; an operative to forecast trend future trend of fashion driven from said analysis step for product preference and analysis result for customer behavior and acquired information on eyeglasses fashion; an operative to acquire future trend of fashion by an artificial intelligent learning tool dedicated to fashion trend forecast, and to generate a knowledge base that advise suited design or proper fashion trend upon customer's request; an operative to generate a promotional contents for eyeglasses for a specific customer based on the integrated information about customer preference obtained from said customer behavior analysis tool, advising information generated by said knowledge base and artificial intelligent learning tool; an operative to acquire and manage demographic information of the user including email address or phone numbers, and to deliver promotional contents to the customer as an 1:1 marketing tool.

111. A device for marketing of eyeglasses according to claim 110, the operative to provide 1:1 marketing tool comprises: an operative to categorize customers by a predefined rule and to generate promotional contents according to said category and to publish promotional contents using 3D simulative features for eyeglasses.

112. A device for marketing of eyeglasses according to claim 110 comprises analysis for the customer that includes at least one parameter for hair texture of 3D face model of the customer, lighting of the face, skin tone, width of the face, length of the face, size of the mouth, interpupillary distance and race of the customer.

113. A device for marketing of eyeglasses according to claim 110 comprises the analysis for the eyeglasses product that includes at least one parameter for size of the frame and lenses, shape of the frame and lenses, material of the frame and lenses, color of the frame, color of the lenses, model year, brand and price.

114. A device for marketing of eyeglasses according to claim 110 comprises analysis for the product preference that includes at least one parameter for seasonal trend in fashion, seasonal trend of eyeglasses shape, width of the face, race, skin tone, interpupillary distance, and hair style in the 3D face model

115. A storage media to read a program from a computer to execute a method in claim 45 by a computer.

116. A storage media to read a program from a computer to execute a method in claim 79 by a computer.
